(19) United States
(12) Patent Application Publication
(10) Pub. No.: US 2024/0409769 A1
(43) Pub. Date: Dec. 12, 2024

(54) A LIGHT-ACTIVATED RESIN COMPOSITION AND ITS USE IN 3D-PRINTING

(71) Applicants: UNIVERSITE DE HAUTE-ALSACE, MULHOUSE (FR); CENTRE NATIONAL DE LA RECHERCHE SCIENTIFIQUE, PARIS (FR); UNIVERSITE D'AIX-MARSEILLE, MARSEILLE (FR)

(72) Inventors: OLIVIER SOPPERA, MULHOUSE (FR); YOHANN GUILLANEUF, MARSEILLE (FR); CONSTANCE THOMAS, ALTKIRCH (FR); NOÉMIE GIL, MARSEILLE (FR); CATHERINE LEFAY, MARSEILLE (FR)

(21) Appl. No.: 18/719,893

(22) PCT Filed: Dec. 16, 2022
(86) PCT No.: PCT/EP2022/086511

§ 371 Date: Jun. 14, 2024

(30) Foreign Application Priority Data
Dec. 17, 2021 (EP) 21306838.0

(51) Int. Cl. C09D 135/02; B29C 64/124; B29K 33/00; B33Y 10/00; B33Y 70/00; C08F 222/10; C09D 4/00

(52) U.S. Cl. CPC C09D 135/02; B29C 64/124; B33Y 70/00; C08F 222/103; C09D 4/00; B29K 2033/08; B29K 2995/0059; B29K 2995/0077; B33Y 10/00; C08F 2800/20

(57) ABSTRACT

The present invention relates to a light-activated resin composition comprising a multi-functional acrylate or methacrylate monomer, a cyclic monomer comprising a cleavable or pre-cleavable group and a photo-initiator. It also relates to a degradable polymer, a degradable 3D-printed article, and to a process for preparing such polymer and article. It further relates to the use of a monomer comprising a thionolactone or sulfide cyclic methacrylate for preparing a degradable 3D-printed article.

### TECHNICAL FIELD

The present invention relates to a light-activated resin composition comprising a multi-functional acrylate or methacrylate monomer, a cyclic monomer comprising a cleavable or pre-cleavable group and a photo-initiator. It also relates to a degradable polymer, a degradable 3D-printed article, and to a process for preparing such polymer and article. It further relates to the use of a monomer comprising a thionolactone or sulfide cyclic methacrylate for preparing a degradable 3D-printed article.

### TECHNICAL BACKGROUND

Additive manufacturing and more specially 3D printing has revolutionized the classic industrial manufacturing by creating directly a 3D object that was designed on a computer using successive layering of materials. The rapid development of this technique was first made by the ease of the fused deposition modeling (FDM) technique that allows to prepare 3D objects by the computer-controlled layer by layer deposition of molten or semi-molten polymer via an extrusion nozzle. However, 3D printing has become very popular with the development of light-cured processes, which are usually referred to as VAT photopolymerization. Among these processes, Digital Light Processing (DLP) has in particular attracted attention due to several attractive features, such as fast build, low resolution (<100 m features), wide ink viscosity tolerance and low cost. This process allows to manufacture a 3D object by the cross-linking of a liquid resin consisting mainly of multifunctional methacrylates or acrylates derivatives. The photopolymerization of acrylates occurs rapidly, with high yields, and generates almost no byproducts. This led to a cross-linked material, the mechanical properties of which could be tuned by the monomers structure. Moreover, such object is constituted by a C—C bond covalent network that imparts a high thermal and chemical stability.

The VAT photopolymerization processes developed so far show however several drawbacks. First, the high stability is not compatible with facile degradability and re/up-cyclability. The high amount of 3D-printed resins will be incinerated or stored in landfills, making this so promising manufacturing process not environment-friendly or sustainable. Secondly, this high stability is also not compatible with subtractive manufacturing, which is a technique where printed materials could be removable or erasable after its formation. Such approach is very interesting to easily remove templates or sacrificial parts of 3D objects, a technique that is widely used when the object is a positive print before casting and lastly decomposed such as in jewelry or to prepare ceramics.

Several solutions have been proposed to overcome such drawbacks. Barner-Kowollik and coll. describe the preparation of resins using new monomers based either on thiol-ene chemistry, TAD-polyether ligation, silane-based monomers, o-nitrobenzyl ester monomers, and chymotrypsin cleavable monomers (Adv. Funct. Mater. 2018, 1801405; Adv. Mater. 2020, 32, e2003060; Nat. Commun. 2018, 9, 2788; Adv. Mater. 2019, 31, e1904085; Adv. Funct. Mater. 2020, 2006998). Stimuli and/or controlled degradation of such resins have been obtained. However, such strategy is not applicable at the industrial scale, in particular because the monomers used to prepare the resins are expensive compared with the acrylate or methacrylate monomers currently used in industry.

Zhao and coll. (Adv. Funct. Mater. 2020, 2007173) and Bowman and coll. (Materials Horizons, 2020, 7, 835) have reported the 3D printing of linear polymers as a way to impart re-printability or recyclability to the printed object. However, such materials have a lower chemical resistance, in particular due to the polymer solubility in organic solvent.

Therefore, there remains a need to provide a cost-effective resin, having suitable mechanical and chemical properties for being used in 3D printing, and easily degradable.

### SUMMARY OF THE INVENTION

In this respect, the inventors have developed a resin that can be prepared by photopolymerization of a composition comprising a multifunctional acrylate and/or methacrylate monomer (M1), a cyclic monomer (M2) able to undergo radical ring-opening, comprising a cleavable or pre-cleavable moiety such as a thiocarbonyl-oxy, carbonyl-oxy, carbonyl-thio, disulfide, silyl ether, or acetal, and having a polymerization rate similar to or higher than that of said acrylate and/or methacrylate monomer, and a photo-initiator. The inventors have demonstrated that the incorporation of said monomer M2 allowed the resin to be efficiently degraded, by using classical degradation conditions. In addition, only a few amount of monomer M2 is required, such that the chemical and mechanical properties of the resin are similar to those of the corresponding resin deprived of such monomer M2. Furthermore, the monomer M2 can be directly incorporated into the resin composition, such that it is possible to impart degradability to conventional and commercially-available resins, thus avoiding the need to develop new resin compositions. The resin of the invention has been successfully applied to 3D printing, in particular VAT photopolymerization, and an effective degradation of the 3D printed articles has been observed.

Hence, the present invention relates to a light-activated resin composition comprising:
a first monomer (M1) comprising at least two functions independently chosen from an acrylate function and a methacrylate function;
a second monomer (M2), being a cyclic monomer able to undergo radical ring-opening and comprising a moiety selected from the group consisting of thiocarbonyl-oxy, carbonyl-oxy, carbonyl-thio, disulfide, silyl ether, and acetal, wherein the polymerization rate of M2 is similar to or higher than that of M1; and
a photo-initiator.

It also relates to a degradable polymer based on the light-activated resin composition as defined herein.

It further relates to a photopolymerization process comprising irradiating a light-activated resin composition as defined herein.

Another object of the present invention is a process for 3D-printing a degradable article comprising irradiating a light-activated resin composition as defined herein, under conditions allowing the formation of a 3D-article.

Another object of the present invention is a degradable 3D-printed article based on a degradable polymer as defined herein.

A further object of the present invention is the use of a monomer comprising a thionolactone or sulfide cyclic methacrylate as defined herein, for preparing a degradable 3D-printed article as defined herein.

### FIGURES

FIG. 1. Photopolymerization kinetics follows by FTIR (conversion of C═C band at 1635 cm⁻¹) under UV exposure of resin compositions comprising i) PETIA+0.2% BAPO+2% DOT (●); ii) PETIA+0.5% BAPO+2% DOT (▴); iii) PETIA+0.5% BAPO (x).

FIG. 2. a) Images of articles made by DLP-printing using a resin of the invention (PETIA+0.2% BAPO+2% DOT); b) Images of articles made by 3D-printing using a resin of the invention (PETIA+0.2% BAPO+2% DOT).

FIG. 3. Dissolution experiments using KOH 5% in MeOH/THF of a microtip prepared with a resin of the invention (PETIA+0.2% BAPO+2% DOT), compared with a microtip of a comparative resin (no DOT).

FIG. 4. Degradation times of 6 μm and 10 μm microtips prepared with a resin of the invention (PETIA+0.2% BAPO+2% DOT), using various degradation conditions FIG. 5. Degradation of a macroscopic article formed by DLP-UV set up printing of a resin of the invention (PETIA+0.2% BAPO+2% DOT), using KOH 5% in MeOH/THF.

FIG. 6. Degradation of hollow cubes formed by 3D-printing of a resin of the invention (PETIA+0.2% BAPO+2% DOT) and 3D-printing of a comparative resin (no DOT) in a solution of KOH 5 wt % in MeOH/THF at room temperature, without stirring (top), and biodegradation of such 3D-printed hollow cubes in a home-made compost (bottom).

FIG. 7. Degradation of Eiffel tower formed by 3D-printing of a resin of the invention (PETIA+0.2% BAPO+2% DOT) and 3D-printing of a comparative resin (no DOT) in a solution of KOH 5 wt % in MeOH/THF at room temperature, without stirring.

FIG. 8. Degradation of stack dices formed by 3D-printing of a resin of the invention (PETIA+0.2% BAPO+2% DOT) and 3D-printing of a comparative resin (no DOT) in a solution of KOH 5 wt % in MeOH/THF at room temperature, without stirring.

FIG. 9. A particular process for preparing an article wherein a non-degradable object made from resin PETIA+0.2% BAPO is embedded in a degradable object made from a resin of the invention (PETIA+0.2% BAPO+2% DOT).

### DETAILED DESCRIPTION OF THE INVENTION

The term “Cₓ-C_{y}” in which x and y are integers, as used in the present disclosure, means that the corresponding hydrocarbon chain comprises from x to y carbon atoms. If, for example, the term C₁-C₆ is used, it means that the corresponding hydrocarbon chain may comprise from 1 to 6 carbon atoms, especially 1, 2, 3, 4, 5 or 6 carbon atoms. If, for example, the term C₂-C₅ is used, it means that the corresponding hydrocarbon chain may comprise from 2 to 5 carbon atoms, especially 2, 3, 4, or 5 carbon atoms.

The term “alkyl” refers to a saturated, linear or branched aliphatic group. The term “C₁-C₆ alkyl” refers to an alkyl having 1 to 6 carbon atoms. Examples of alkyl (or C₁-C₆ alkyl) include, but are not limited to methyl, ethyl, propyl, isopropyl, butyl, isobutyl, tert-butyl, pentyl, or hexyl.

The term “alkenyl” refers to an unsaturated, linear, or branched aliphatic group, having at least one carbon-carbon double bond. The term “C₂-C₆ alkenyl” refers to an alkenyl having 2 to 6 carbon atoms. The term alkenyl (or C₂-C₆ alkenyl) includes for instance ethenyl, propenyl, butenyl, pentenyl, or hexenyl.

The term “alkynyl” refers to an unsaturated, linear or branched aliphatic group, having at least one carbon-carbon triple bond. The term “C₂-C₆ alkynyl” refers to an alkynyl having 2 to 6 carbon atoms. The term alkynyl (or C₂-C₆ alkynyl) includes for instance ethynyl, propynyl, butynyl, pentynyl, or hexynyl.

The term «heteroalkyl» refers to an alkyl as defined herein, wherein the aliphatic carbon chain comprises at one or both of its two ends (in particular, the end attached to the remainder of the molecule), and/or is interrupted by at least one heteroatom such as O, N or S. Examples of heteroalkyl are in particular alkoxy (—O-alkyl), alkylthio (—S-alkyl), and alkylamino (—NH(alkyl) or —N(alkyl)₂). A «C₁-C₆ heteroalkyl» refers to a heteroalkyl having 1 to 6 carbon atoms and at least one heteroatom such as 0, N or S. Examples of heteroalkyl (or C₁-C₆ heteroalkyl) include, but are not limited to, methoxy, ethoxy, propyloxy, isopropyloxy, butyloxy, isobutyloxy, tert-butyloxy, pentyloxy, hexyloxy, methylthio, ethylthio, propylthio, isopropylthio, butylthio, isobutylthio, tert-butylthio, pentylthio, hexylthio, methylamino, ethylamino, propylamino, isopropylamino, butylamino, isobutylamino, tert-butylamino, pentylamino, or hexylamino.

The term “cycloalkyl” refers to a saturated or unsaturated mono-, bi- or tri-cyclic aliphatic group. It also includes fused, bridged, or spiro-connected cycloalkyl groups. The term “C₃-C₁₂ cycloalkyl” refers to a cycloalkyl having 3 to 12 carbon atoms. Examples of cycloalkyl (or C₃—C₁₂ cycloalkyl) include, but are not limited to cyclopropyl, cyclobutyl, cyclopentyl, cyclohexyl, cycloheptyl, cyclooctyl, cyclononyl, cyclodecyl, cycloundecyl or cyclododecyl. The term “cycloalkyl” may also refer to a bridged carbocyclyl such as bicyclo[2,2,1]heptanyl, bicyclo[2,2,2]octanyl, or adamantyl, preferably bicyclo[2,2,1]heptanyl.

The term “heterocycloalkyl” corresponds to a saturated or unsaturated cycloalkyl group as above defined in which at least one carbon atom has been replaced with a heteroatom selected from nitrogen, oxygen, or sulphur atom. Advantageously, the heterocycloalkyl comprises between 3 and 12 ring atoms, wherein at least one of the ring atoms is a heteroatom such as nitrogen, oxygen or sulphur atom. In the case of a bi- or tricycle, the cycles can be fused, bridged or have a spiro configuration. The term heterocycloalkyl includes for instance aziridinyl, azepanyl, diazepanyl, dioxolanyl, benzo [1,3] dioxolyl, azetidinyl, oxetanyl, pyrazolinyl, pyranyl, thiomorpholinyl, pyrazolidinyl, piperidyl, piperazinyl, 1,4-dioxanyl, imidazolinyl, pyrrolinyl, pyrrolidinyl, piperidinyl, imidazolidinyl, morpholinyl, 1,4-dithianyl, pyrrolidinyl, pyrimidinyl, oxozolinyl, oxazolidinyl, isoxazolinyl, isoxazolidinyl, thiooxetanyl, thiopyranyl, thiomorpholinyl, thiazolinyl, thiazolidinyl, isothiazolinyl, isothiazolidinyl, dihydropyranyl, dihydrofuranyl, dihydrothiopyranyl, dihydrothiophenyl, dihydropiperidinyl, tetrahydropiperidinyl, tetrahydrothiopyranyl, tetrahydropyranyl, tetrahydrofuranyl, and tetrahydrothiophenyl.

“Cycloalkyl” and “heterocycloalkyl” also include cycloalkenyl and heterocycloalkenyl which correspond respectively to a cycloalkyl having at least one carbon-carbon double bond and a heterocycloalkyl having at least one carbon-carbon double bond such as cyclohexenyl, and dihydropyranyl.

The term “aryl” refers to a mono- or bi-cyclic aromatic hydrocarbon having from 6 to 12 carbon atoms. For instance, the term “aryl” includes phenyl, biphenyl, or naphthyl. In a preferred embodiment, the aryl is a phenyl.

The term “heteroaryl” as used herein corresponds to an aromatic, mono- or poly-cyclic group comprising between 5 and 14 ring atoms, wherein at least one of the ring atoms is a heteroatom such as nitrogen, oxygen or sulphur atom. As used herein, the term “heteroaryl” further includes the “fused arylheterocycloalkyl” and “fused heteroarylcycloalkyl”. The terms “fused arylheterocycloalkyl” and “fused heteroarylcycloalkyl” correspond to a bicyclic group in which an aryl as above defined or a heteroaryl is respectively bounded to the heterocycloalkyl or the cycloalkyl as above defined by at least two carbons. In other terms, the aryl or the heteroaryl shares a carbon bond with the heterocycloalkyl or the cycloalkyl. Examples of such mono- and poly-cyclic heteroaryl group, fused arylheterocycloalkyl and fused arylcycloalkyl may be: pyridinyl, thiophenyl, furanyl, pyrrolyl, pyrazolyl, imidazolyl, oxazolyl, isoxazolyl, thiazolyl, isothiazolyl, triazolyl, tetrazolyl, oxadiazolyl, furazanyl, thiadiazolyl, tetrazolyl, benzofuranyl, thianaphthalenyl, indolyl, indolinyl, indanyl, quinolinyl, isoquinolinyl, benzimidazolyl, tetrahydroquinolinyl, tetrahydroisoquinolinyl, triazinyl, thianthrenyl, benzofuranyl, dihydrobenzofuranyl, isobenzofuranyl, benzothiophenyl, isobenzothiophenyl, chromenyl, xanthenyl, phenoxanthinyl, pyrazinyl, pyridazinyl, indolizinyl, isoindolyl, indazolyl, purinyl, quinolizinyl, phtalazinyl, naphthyridinyl, quinoxalinyl, quinazolinyl, cinnolinyl, pteridinyl, carbazolyl, O-carbolinyl, phenanthridinyl, acridinyl, pyrimidinyl, phenanthrolinyl, phenazinyl, phenothiazinyl, furazanyl, phenoxazinyl, isochromanyl, chromanyl, imidazolidinyl, imidazolinyl, pyrazolidinyl, pyrazolinyl, indolinyl, isoindolinyl, oxazolidinyl, benzotriazolyl, benzoisoxazolyl, oxindolyl, benzoxazolyl, benzoxazolinyl, benzoxazinyl, benzothienyl, benzothiazolyl, benzodiazepinyl, benzazepinyl, benzoxazepinyl, isatinyl, dihydrobenzodioxepinyl, dihydropyridyl, pyrimidinyl, s-triazinyl, oxazolyl, or thiofuranyl. A fused arylheterocycloalkyl is for instance an indolinyl (phenyl fused to a pyrrolidinyl) and a dihydrobenzofuranyl (phenyl fused to a dihydrofuranyl).

The term “carbocycle” refers to a saturated or unsaturated, aliphatic or aromatic, mono- or poly-cyclic hydrocarbon group. The term “C₃-C₁₂ carbocycle” refers to a carbocycle having 3 to 12 carbon atoms. In a particular embodiment, the C₃-C₁₂ carbocycle is a C₃-C₁₂ cycloalkyl or an aryl.

The term “perfluoroalkyl” refers to an alkyl as defined above wherein all the hydrogen atoms have been replaced with fluorine atoms. The term “C₁-C₆ perfluoroalkyl” refers to a perfluoroalkyl having 1 to 6 carbon atoms. An example of perfluoroalkyl (or C₁-C₆ perfluoroalkyl) includes, but is not limited to, trifluoromethyl.

The term “halogen” corresponds to a fluorine, chlorine, bromine, or iodine atom, preferably a fluorine, chlorine or bromine, more preferably a chlorine or a fluorine.

The term “ester” refers to a —C(O)OR or RC(O)O— group, wherein R is any hydrocarbon group. In a particular embodiment, R is a C₁-C₆ alkyl, a C₃-C₁₂ cycloalkyl or an aryl.

The term “ketone” refers to a —C(O)R′ group, wherein R′ is any hydrocarbon group. In a particular embodiment, R′ is a C₁-C₆ alkyl, a C₃-C₁₂ cycloalkyl or an aryl.

The term “amido” refers to a —C(O)N(R″)₂ group, wherein each R″ is independently a hydrogen or a hydrocarbon group. In a particular embodiment, each R″ is independently a hydrogen, a C₁-C₆ alkyl, a C₃-C₁₂ cycloalkyl or an aryl.

The term “sulfonyl” refers to a —S(O)₂—R′″ group, wherein R′″ is any hydrocarbon group. In a particular embodiment, R′″ is a C₁-C₆ alkyl, a C₃-C₁₂ cycloalkyl or an aryl.

The term “alkylene” refers to a divalent, saturated, linear or branched aliphatic group. Examples of alkylene having 1 to 11 carbon atoms include, but are not limited to, methylene, ethylene, propylene, butylene, isobutylene, pentylene, isopentylene, hexylene, heptylene, octylene, nonylene, decylene, or undecylene.

The alkyl, alkenyl, alkynyl, heteroalkyl, cycloalkyl, heterocycloalkyl, aryl, heteroaryl, carbocycle and alkylene groups as defined herein are optionally substituted. The expression “optionally substituted” means non-substituted or substituted by one or more (for instance, one, two, three or four, preferably one or two, more preferably one) substituents. Examples of substituents include, but are not limited to, a C₁-C₆ perfluoroalkyl (e.g. —CF₃), a nitro (—NO₂), a cyano (—CN), —SO₃H, —OH, —SH, —NH₂, —COOH, a halogen, a C₁-C₆ alkyl, a C₃-C₁₂ cycloalkyl, an aryl, an ester, a ketone.

As used herein, the expression “light-activated resin composition” refers to a composition, typically in the form of a liquid solution or suspension, which can be converted into a resin by light-activation. The light-activation is an activation by any light, typically an activation by a light composed of one or more wavelengths comprised between 100 nm and 1500 nm. Preferably, said light is an ultra-violet (UV) light, a visible light, or a near-infra-red (IR) light, preferably a UV light. A UV light has typically a wavelength comprised between 100 nm and 390 nm. A visible light has typically a wavelength comprised between 390 nm and 700 nm. A near-IR light has typically a wavelength comprised between 700 nm and 1500 nm.

The light-activated resin composition of the invention comprises:
a first monomer (M1) comprising at least two functions independently chosen from an acrylate function and/or a methacrylate function;
a second monomer (M2), being a cyclic monomer able to undergo radical ring-opening and comprising a moiety selected from the group consisting of thiocarbonyl-oxy, carbonyl-oxy, carbonyl-thio, disulfide, silyl ether, and acetal, wherein the polymerization rate of M2 is similar to or higher than that of M1; and
a photo-initiator.

The first monomer M1 is a multi-functional acrylate and/or methacrylate monomer, or a mixture of different multi-functional acrylate and/or methacrylate monomers. The first monomer M1 comprises at least two (for instance, two, three, four or five, preferably two or three, more preferably three) functions independently chosen from an acrylate function and a methacrylate function.

An acrylate function may in particular be represented as follows:

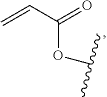 [SMILES: *OC(=O)C=C]

in which

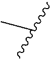

denotes the bond by which said acrylate function is attached to the remainder of the first monomer.

A methacrylate function may in particular be represented as follows:

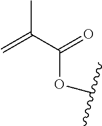 [SMILES: *OC(=O)C(=C)C]

in which

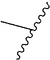

denotes the bond by which said methacrylate function is attached to the remainder of the first monomer.

In a particular embodiment, the first monomer M1 comprises at least two (for instance, two, three, four or five, preferably two or three, more preferably three) functions, wherein each of said functions is an acrylate function. In a more particular embodiment, the first monomer M1 is chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), ethylene glycol diacrylate, diethylene glycol diacrylate, triethylene glycol diacrylate, polyethylene glycol diacrylate (PEGDA), propylene glycol diacrylate, dipropylene glycol diacrylate, tripropylene glycol diacrylate, polypropylene glycol diacrylate, bisphenol A ethoxylate diacrylate (Bis-EDA), and mixtures thereof.

In another particular embodiment, the first monomer M1 comprises at least two (for instance, two, three, four or five, preferably two or three, more preferably three) functions, wherein each of said functions is a methacrylate function. In another more particular embodiment, the first monomer M1 is chosen from ethylene glycol dimethacrylate, diethylene glycol dimethacrylate, triethylene glycol dimethacrylate (TEGDMA), polyethylene glycol dimethacrylate, propylene glycol dimethacrylate, dipropylene glycol dimethacrylate, tripropylene glycol dimethacrylate, polypropylene glycol dimethacrylate, 2,2-bis-4-(methacryloxy ethoxy)phenylpropane, tricylodecane dimethanol dimethacrylate, 1,10-decanediol dimethacrylate, 1,6-hexanediol dimethacrylate, 1,9-nonanediol dimethacrylate, neopentylglycol dimethacrylate, 2-hydroxy 1,3-dimethacryloxy propane, trimethyolpropane trimethacrylate, ethoxylated trimethyol propane trimethacrylate, ditrimethyolpropane tetramethacrylate, tris (2-hydroxy ethyl) isocyanurate trimethacrylate, diurethane dimethacrylate (UDMA), dipentaerythritol pentamethacrylate, ethyoxylated pentaerythritol tetramethacrylate, propoxylated glyceryl trimethacrylate, propoxylated trimethylolpropane trimethacrylate, bisphenol A glycidyl methacrylate (Bis-GMA), and mixtures thereof.

In a preferred embodiment, the first monomer is chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), triethylene glycol dimethacrylate (TEGDMA), polyethylene glycol diacrylate (PEGDA), diurethane dimethacrylate (UDMA), bisphenol A glycidyl methacrylate (Bis-GMA), bisphenol A ethoxylate diacrylate (Bis-EDA) and mixtures thereof.

In a more preferred embodiment, the first monomer M1 is PETIA.

The molecular weight of the first monomer M1 is not particularly limited. Typically, its molecular weight is comprised between 50 and 800 g/mol, for instance between 500 and 800 g/mol.

In a particular embodiment, the first monomer M1 is in a prepolymer (or equivalently “oligomer”) form. In such embodiment, the molecular weight of the prepolymer can for instance be comprised between 100 and 100 000 g/mol.

The amount of first monomer M1 in the composition of the invention is advantageously from 1 to 98.9 wt %, preferably from 10 to 98.9 wt %, more preferably from 40 to 98.9 wt %, even more preferably from 60 to 98 wt %, relative to the total weight of the composition.

The second monomer M2 is a cyclic monomer able to undergo radical ring-opening, comprising a moiety selected from the group consisting of thiocarbonyl-oxy (—C(S)O— or equivalently —OC(S)—), carbonyl-oxy (i.e. —C(O)O— or equivalently —OC(O)—), carbonyl-thio (i.e. —C(O)S— or equivalently —SC(O)—), disulfide, silyl ether, and acetal, and having a polymerization rate similar to or higher than that of M1.

Preferably, the second monomer M2 is a cyclic monomer able to undergo radical ring-opening, comprising a moiety selected from the group consisting of thiocarbonyl-oxy (—C(S)O— or equivalently —OC(S)—), carbonyl-oxy (i.e. —C(O)O— or equivalently —OC(O)—), carbonyl-thio (i.e. —C(O)S— or equivalently —SC(O)—), disulfide, and silyl ether, and having a polymerization rate similar to or higher than that of M1.

Preferably, the second monomer M2 is a cyclic monomer able to undergo radical ring-opening, comprising a moiety selected from the group consisting of thiocarbonyl-oxy (—C(S)O— or equivalently —OC(S)—), carbonyl-oxy (i.e. —C(O)O— or equivalently —OC(O)—), carbonyl-thio (i.e. —C(O)S— or equivalently —SC(O)—), and having a polymerization rate similar to or higher than that of M1.

In a particular embodiment, the second monomer M2 is a cyclic monomer able to undergo radical ring-opening, comprising a thiocarbonyl-oxy moiety (—C(S)O— or equivalently —OC(S)—), and having a polymerization rate similar to or higher than that of M1.

Preferably, the second monomer M2 is a cyclic monomer able to undergo radical ring-opening, comprising a moiety selected from the group consisting of carbonyl-oxy (i.e. —C(O)O— or equivalently —OC(O)—) or carbonyl-thio (i.e. —C(O)S— or equivalently —SC(O)—), and having a polymerization rate similar to or higher than that of M1.

As used herein, a cyclic monomer “able to undergo radical ring-opening” refers to a cyclic compound which can be opened by a radical species, said radical species being for instance derived from a photoinitiator or a polymer chain in growth. More particularly, said opening can occur by addition of said radical species on a site of the monomer and a subsequent break of a bond of the cyclic chain, that is typically adjacent to said site.

According to the present invention, the polymerization rate of monomer M2 is similar to (preferably “equal to”) or higher than the polymerization rate of monomer M1 (or each of monomers M1 when a mixture of monomers M1 is comprised in the composition).

The expression “similar to the polymerization rate of monomer M1” means ±20%, preferably +10%, more preferably ±5% of the polymerization rate of monomer M1.

In a particular embodiment, the ratio of the polymerization rate of M2 to the polymerization rate of M1 is comprised between 0.8 and 1.2, preferably between 0.9 and 1.1. The polymerization rate of a monomer, or a ratio of polymerization rates, can be determined by ¹H NMR or Infra-Red spectroscopy (preferably by ¹H NMR spectroscopy). The determination of the polymerization rate of a monomer, or a ratio of polymerization rates is in particular described in Smith, et al. J. Am. Chem. Soc. 2019, 141 (4), 1446 or O. Soppera et al. J Polym Sci Pol Chem 2003, 41, 716.

The second monomer comprises a cleavable or pre-cleavable moiety. Said moiety is selected from the group consisting of thiocarbonyl-oxy (—C(S)O— or equivalently —OC(S)—), carbonyl-oxy (i.e. —C(O)O— or equivalently —OC(O)—), carbonyl-thio (i.e. —C(O)S— or equivalently —SC(O)—), disulfide (—S—S—), silyl ether, and acetal.

As used herein, a “cleavable moiety” denotes a moiety capable of being cleaved, preferably selectively cleaved, by a chemical or biological reaction.

As used herein, a “pre-cleavable moiety” denotes a moiety that can be converted into a cleavable moiety after radical ring-opening of monomer M2. For instance, the second monomer M2 can comprise a thiocarbonyl-oxy, which is a pre-cleavable moiety that can be converted into a cleavable carbonyl-thio after radical ring-opening of said monomer.

The cleavable or pre-cleavable moiety is preferably contained within the cyclic structure of the second monomer.

As used herein, a “silyl ether” refers to a moiety of the following formula:

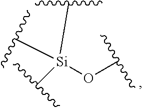 [SMILES: *O[Si](*)(*)*]

in which

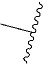

denotes the bond by which the function is attached to the remainder of the monomer. In a monomer containing a silyl ether, the Si—O atoms are typically bound to hydrocarbon chains constituting the remainder of the monomer.

As used herein, an “acetal” refers to a moiety of the following formula:

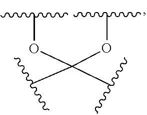 [SMILES: *OC(*)(*)O*]

in which

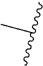

denotes the bond by which the function is attached to the remainder of the monomer. In a monomer containing an acetal, the O—C—O atoms are typically bound to hydrocarbon chains constituting the remainder of the monomer.

In a particular embodiment, the second monomer comprises a thiocarbonyl-oxy. Such moiety is typically a pre-cleavable moiety.

In another particular embodiment, the second monomer comprises a carbonyl-oxy or a carbonyl-thio. Such moieties are typically cleavable.

In one embodiment, said second monomer M2 comprises a thionolactone or sulfide cyclic methacrylate.

As used herein, a “thionolactone” refers to a cyclic thionoester group, namely a cyclic group having a thiocarbonyl-oxy —C(S)O— (or equivalently —OC(S)—) group within the cycle. A thionolactone can be schematized as follows:

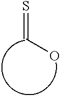

wherein the circle arc denotes a hydrocarbon chain.

In a particular embodiment, the second monomer is represented by the following formula (Ia):

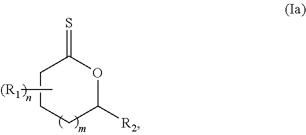

wherein:
m is 0, 1, 2 or 3,
n is from 0 to (2m+5), and
each R₁ is independently selected from the group consisting of a hydrogen, a halogen, a C₁-C₆ alkyl, a C₂-C₆ alkenyl, a C₂-C₆ alkynyl, a C₁-C₆ heteroalkyl, a C₃-C₁₂ cycloalkyl, a heterocycloalkyl, an aryl, a heteroaryl, a cyano, a nitro, —C(O)OH, —C(O)H, —OH, —SH, a C₁-C₆ perfluoroalkyl, an ester, a ketone, a sulfonyl, and an amido,
R₂ is selected from the group consisting of a hydrogen, a halogen, a C₁-C₆ alkyl, a C₂-C₆ alkenyl, a C₂-C₆ alkynyl, a C₁-C₆ heteroalkyl, a C₃-C₁₂ cycloalkyl, a heterocycloalkyl, an aryl, a heteroaryl, a cyano, a nitro, —C(O)OH, —C(O)H, —OH, —SH, a C₁-C₆ perfluoroalkyl, an ester, a ketone, a sulfonyl, and an amido,
   or two adjacent R₁, or adjacent R₁ and R₂, can form together with the carbon atoms to which they are attached a C₃-C₁₂ carbocycle (such as a phenyl).

In the above formula (Ia), n represents the number of R₁ substituting the cycle. The maximal number of R₁, namely (2m+5), depends on the size of the cycle defined by m. For instance:
if m=0, then n is from 0 to 5;
if m=1, then n is from 0 to 7;
if m=2, then n is from 0 to 9;
if m=3, then n is from 0 to 11.

Each R₁ can be substituent on any carbon atom on the cycle, and formula (Ia) encompasses all the combinations in terms of substitutions. For instance, in an embodiment where m=1 and n=2, formula (Ia) encompasses the following formulae (not limitative):

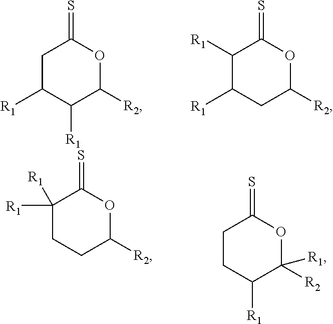

in which each R₁ and R₂ are as defined above. It is to be understood that the R₁ can be different or identical to each other.

In a particular embodiment, the second monomer is a compound of formula (Ia) in which m is 2.

In another particular embodiment, the second monomer is a compound of formula (Ia) in which n is 0, 1, 2, 3 or 4. Preferably, n is 0 or 1.

In an embodiment where n is 0, the compound of formula (Ia) can be represented as follows:

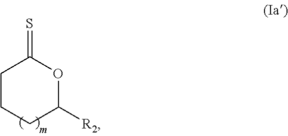

in which m and R₂ are as defined above. In such embodiment, m is preferably 2.

It is understood that an embodiment where n is 0 is equivalent to an embodiment where n is different from 0 and all R₁ are hydrogens.

In an embodiment where n is 1, the second monomer is a compound of formula (Ia) is preferably represented as follows:

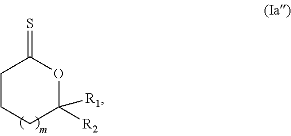

in which m, R₁ and R₂ are as defined herein. In such embodiment, m is preferably 2.

In a particular embodiment, R₂ is selected from the group consisting of a C₂-C₆ alkynyl, an aryl, a heteroaryl, a cyano, a nitro, —C(O)OH, —C(O)H, an ester, a ketone, a sulfonyl, and an amido.

Preferably, R₂ is a cyano or an aryl (where a preferred aryl is a phenyl).

In another particular embodiment, each R₁ is independently selected from the group consisting of a hydrogen, or a C₁-C₆ alkyl, or two adjacent R₁, can form together with the carbon atoms to which they are attached a C₃-C₁₂ carbocycle (such as a phenyl).

In an embodiment where n is 1, R₁ is preferably a hydrogen or a C₁-C₆ alkyl.

In a preferred embodiment, the second monomer is represented by any one of the following formulae:

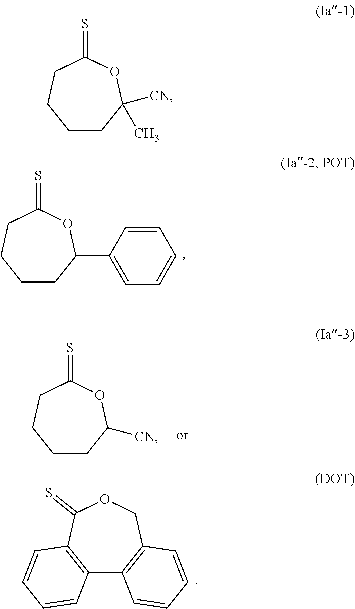

In a more preferred embodiment, the second monomer is represented by the following formula (DOT):

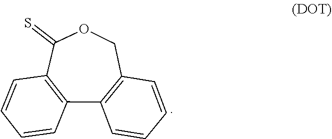 [SMILES: S=C1OCc2ccccc2-c2ccccc21]

In another embodiment, the second monomer is represented by the above formula (Ia″-1).

In another embodiment, the second monomer is represented by the above formula (Ia″-2).

In another embodiment, the second monomer is represented by the above formula (Ia″-3).

As used herein, a “sulfide cyclic methacrylate” refers to a cyclic group having a moiety represented as follows within its cycle:

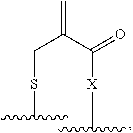

wherein X is O or S.

In a particular embodiment, the second monomer is represented by the following formula (Ib):

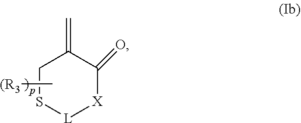

wherein:
X is O or S (preferably O),
L represents an alkylene chain having k carbon atoms and being optionally interrupted by one or more (preferably one or two) groups independently chosen from —C(O)O— and —S—S—,
k is from 1 to 11 (preferably from 2 to 11, more preferably from 2 to 8),
p is from 0 to (2k+2), and
each R₃ is independently selected from the group consisting of a hydrogen, a halogen, a C₁-C₆ alkyl, a C₂-C₆ alkenyl, a C₂-C₆ alkynyl, a C₁-C₆ heteroalkyl, a C₃-C₁₂ cycloalkyl, a heterocycloalkyl, an aryl, a heteroaryl, a cyano, a nitro, —C(O)OH, —C(O)H, —OH, —SH, a C₁-C₆ perfluoroalkyl, an ester, a ketone, a sulfonyl, and an amido, or two adjacent R₃ can form together with the carbon atoms to which they are attached a C₃-C₁₂ carbocycle (such as a phenyl).

In the above formula (Ib), k represents the number of carbon atoms in the alkylene chain excluding the carbon atom of the optional group(s) —C(O)O—.

In the above formula (Ib), p represents the number of R₃ substituting the cycle. The maximal number of R₃, namely (2k+2), depends on the size of the L chain defined by k. For instance:
if k=1, then p is from 0 to 4;
if k=2, then p is from 0 to 6.

Each R₃ can be substituents on any carbon atom on the cycle, and formula (Ib) encompasses all the combinations in terms of substitutions. For instance, in an embodiment where L is alkylene having one carbon atom (k=1) and where p=2, formula (Ib) encompasses the following formulae:

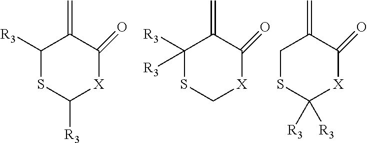

in which X and R₃ are as defined above. It is to be understood that the R₃ can be different or identical to each other.

In a particular embodiment, p is 0, 1, or 2 (preferably p is 0). It is understood that an embodiment where p is 0 is equivalent to an embodiment where p is different from 0 and all R₃ are hydrogens.

In a particular embodiment, each R₃ are chosen from a hydrogen and C₁-C₆ alkyl.

In another particular embodiment, L represents an alkylene chain having k carbon atoms, where k is from 1 to 11 (preferably from 2 to 11, more preferably from 2 to 8).

In another particular embodiment, L represents an alkylene chain having k carbon atoms, where k is from 1 to 11 (preferably from 2 to 11, more preferably from 2 to 8), and being interrupted by one —C(O)O— group and optionally, being further interrupted by one —S—S— group.

In a preferred embodiment, the second monomer is represented by any one of the following formulae (SCM1) to (SCM7):

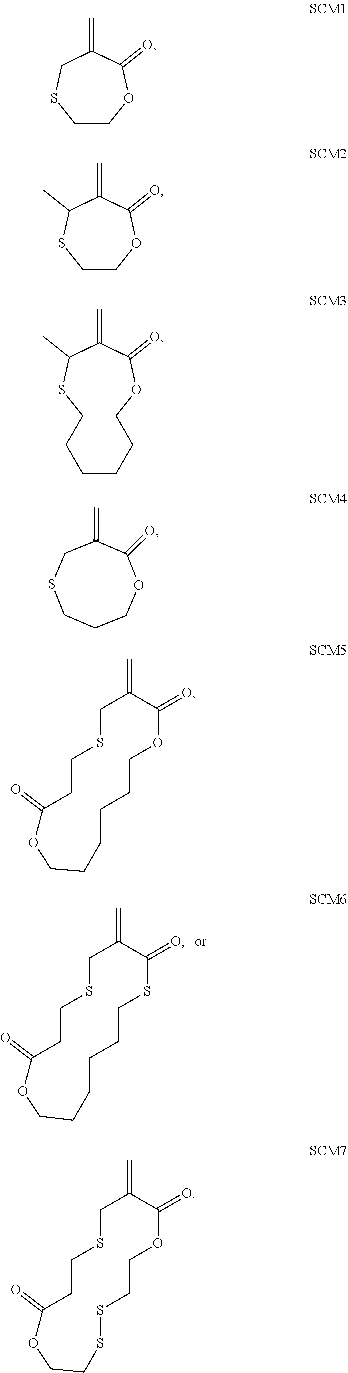

invention may be from 5/1000 to 95/5, preferably from 1/100 to 20/100, more preferably from 1/100 to 5/100, even more preferably from 1/100 to 3/100, for instance from 1.5/100 to 2.5/100.

In a particular embodiment, the composition of the invention advantageously comprises an amount of the first monomer M1 from 40 to 98.9 wt %, preferably from 60 to 98 wt %, relative to the total weight of the composition, and has a weight ratio of the second monomer M2 to the first monomer M1 of from 1/100 to 20/100, preferably from 1/100 to 5/100, more preferably from 1/100 to 3/100, for instance from 1.5/100 to 2.5/100.

In a more particular embodiment, the composition of the invention advantageously comprises an amount of the first monomer M1 from 60 to 98 wt % relative to the total weight of the composition and has a weight ratio of the second monomer M2 to the first monomer M1 of from 1/100 to 5/100, preferably from 1/100 to 3/100, more preferably from 1.5/100 to 2.5/100.

The composition of the invention also comprises a photo-initiator. As used herein, a “photo-initiator” denotes an organic compound which is able to generate radicals upon activation by light, typically activation by a light composed of one or more wavelength(s) comprised between 100 nm and 1500 nm. In a particular embodiment, the photo-initiator is activated by a ultra-violet (UV) light, a visible light, or a near-infra-red (IR) light, preferably a UV light.

The photo-initiator of the composition of the invention can be chosen among known photo-initiators used in photopolymerization.

### UV Photo-Initiators:

According to one embodiment, the photo-initiator is selected from the group consisting of benzoin ethers, substituted acetophenones, derivatives of phosphine oxides, amino-ketones, oxysulfonyl ketones, sulfonyl ketones, metallocenes and the azo-type compounds.

In a particular embodiment, the photo-initiator is chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof.

### Visible Photo-Initiators:

According to another embodiment, the photo-initiator is a photosensitive system consisting of a combination of a first compound and a second compound, which typically operate together by hydrogen abstraction reaction and/or electron transfer. In such embodiment:
said first compound is selected from the group consisting of
   weakly basic amines, preferably tertiary amines, more preferably the hydroxy-alkyl amines, especially methyldiethanolamine, benzylamines, aniline derivatives, more particularly the ethyl paradimethylaminobenzoate, N-phenylglycine, and
   ascorbic acid, and
said second compound is selected from the group consisting of acridines, preferably acriflavine or acridine orange; phenazines, preferably Safranin O; oxazines; thiazines, preferably Blue methylene or thionine; xanthenes, preferably Eosin Y, Rose Bengal or Erythrosin; rhodamines; thioxanthenes; polymethines; ketocoumarins and thioxanthones.

According to another embodiment, the photo-initiator is a photosensitive system consisting of a combination of a first compound and a second compound, which typically operate together by energy transfer. In such embodiment:
said first compound being selected from the group consisting of benzoin ethers, preferably 2,2-dimethoxy-2-phenyl acetophenone; or substituted acetophenones such as 2-hydroxy-2-methyl-1-phenyl-propan-1-one or 2-methyl-1-[4-(methylthio)phenyl]-2-morpholinopropan-1-one,
and said second compound being selected from the group consisting of thioxanthone derivatives, preferably isopropylthioxanthone or chlorothioxanthone; and the couramines or derivatives thereof.

### IR (1-Photon) Photo-Initiators:

Preferably, when absorption is sought in the near infrared range, the photo-initiator is an organic dye, such as a polymethine, in particular a cyanine. The cyanine is preferably a carbocyanine, a phtalocyanine, a naphtalocyanine with a counter ion, such as iodides, perchlorates, and metal complexes from these dyes, such as cobalt, aluminum, copper, iron, lead, magnesium, nickel, silicon, tin, titanium, vanadium or zinc metal complexes.

In particular, the photo-initiator may be an indotricarbocyanine (HITC). The photoinitiator may also be a combination of indotricarbocyanine and methyl diethanolamine

### IR (2-Photon) Photo-Initiatiors:

In a particular embodiment, the photo-initiator is compatible with the TPS method (multi-photon technology) and exhibit a 2-photon action cross section of at least 0.1 GM, preferably higher than 1 GM, advantageously higher than 100 GM. A suitable 2-photon action cross section is characterized by a good 2-photon absorption cross-section and/or a good yield of production of radicals from excited states.

In such embodiment, the photoinitiator typically has a two-photon absorption section suitable for two-photon absorption for two-photon polymerization with wavelengths comprised between 200 nm and 1500 nm, preferentially from 500 nm to 1000 nm, advantageously from 700 nm to 850 nm.

Preferably, the photo-initiator is phenylbis(2,4,6-trimethylbenzoyl)phosphine oxide (BAPO).

The weight ratio of photo-initiator to the first monomer M1 in the composition of the invention may be from 1/1000 to 5/100, preferably from 1/1000 to 1/100, more preferably from 2/1000 to 5/1000.

In a particular embodiment, the composition of the invention advantageously comprises:
an amount of the first monomer M1 from 40 to 98.9 wt %, preferably from 60 to 98 wt %, relative to the total weight of the composition;
a weight ratio of the second monomer M2 to the first monomer M1 of from 1/100 to 20/100, preferably from 1/100 to 5/100, more preferably from 1/100 to 3/100, for instance from 1.5/100 to 2.5/100; and
a weight ratio of photo-initiator to the first monomer M1 of from 1/1000 to 5/100, preferably from 1/1000 to 1/100, more preferably from 2/1000 to 5/1000.

In a particular embodiment, the composition of the invention comprises:
a first monomer M1 chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), ethylene glycol diacrylate, diethylene glycol diacrylate, triethylene glycol diacrylate, polyethylene glycol diacrylate (PEGDA), propylene glycol diacrylate, dipropylene glycol diacrylate, tripropylene glycol diacrylate, polypropylene glycol diacrylate, bisphenol A ethoxylate diacrylate (Bis-EDA), ethylene glycol dimethacrylate, diethylene glycol dimethacrylate, triethylene glycol dimethacrylate (TEGDMA), polyethylene glycol dimethacrylate, propylene glycol dimethacrylate, dipropylene glycol dimethacrylate, tripropylene glycol dimethacrylate, polypropylene glycol dimethacrylate, 2,2-bis-4-(methacryloxy ethoxy)phenylpropane, tricylodecane dimethanol dimethacrylate, 1,10-decanediol dimethacrylate, 1,6-hexanediol dimethacrylate, 1,9-nonanediol dimethacrylate, neopentylglycol dimethacrylate, 2-hydroxy 1,3-dimethacryloxy propane, trimethyolpropane trimethacrylate, ethoxylated trimethyol propane trimethacrylate, ditrimethyolpropane tetramethacrylate, tris (2-hydroxy ethyl) isocyanurate trimethacrylate, diurethane dimethacrylate (UDMA), dipentaerythritol pentamethacrylate, ethyoxylated pentaerythritol tetramethacrylate, propoxylated glyceryl trimethacrylate, propoxylated trimethylolpropane trimethacrylate, bisphenol A glycidyl methacrylate (Bis-GMA), and mixtures thereof, preferably PETIA;
a second monomer M2 as defined above (preferably a compound of formula (Ia) or (Ib), more preferably DOT); and
a photo-initiator chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof, preferably BAPO.

In a more particular embodiment, the composition of the invention comprises:
a first monomer M1 chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), triethylene glycol dimethacrylate (TEGDMA), polyethylene glycol diacrylate (PEGDA), diurethane dimethacrylate (UDMA), bisphenol A glycidyl methacrylate (Bis-GMA), bisphenol A ethoxylate diacrylate (Bis-EDA) and mixtures thereof, preferably PETIA;
a second monomer M2 as defined above (preferably a compound of formula (Ia) or (Ib), more preferably DOT); and
a photo-initiator chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof, preferably BAPO.

In a particular embodiment, the composition of the invention comprises:
a first monomer M1 chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), ethylene glycol diacrylate, diethylene glycol diacrylate, triethylene glycol diacrylate, polyethylene glycol diacrylate (PEGDA), propylene glycol diacrylate, dipropylene glycol diacrylate, tripropylene glycol diacrylate, polypropylene glycol diacrylate, bisphenol A ethoxylate diacrylate (Bis-EDA), ethylene glycol dimethacrylate, diethylene glycol dimethacrylate, triethylene glycol dimethacrylate (TEGDMA), polyethylene glycol dimethacrylate, propylene glycol dimethacrylate, dipropylene glycol dimethacrylate, tripropylene glycol dimethacrylate, polypropylene glycol dimethacrylate, 2,2-bis-4-(methacryloxy ethoxy)phenylpropane, tricylodecane dimethanol dimethacrylate, 1,10-decanediol dimethacrylate, 1,6-hexanediol dimethacrylate, 1,9-nonanediol dimethacrylate, neopentylglycol dimethacrylate, 2-hydroxy 1,3-dimethacryloxy propane, trimethyolpropane trimethacrylate, ethoxylated trimethyol propane trimethacrylate, ditrimethyolpropane tetramethacrylate, tris (2-hydroxy ethyl) isocyanurate trimethacrylate, diurethane dimethacrylate (UDMA), dipentaerythritol pentamethacrylate, ethyoxylated pentaerythritol tetramethacrylate, propoxylated glyceryl trimethacrylate, propoxylated trimethylolpropane trimethacrylate, bisphenol A glycidyl methacrylate (Bis-GMA), and mixtures thereof, preferably PETIA;
a second monomer M2 which is a compound of formula (Ia), preferably selected from the group consisting of compounds of above formula (Ia″-1), (Ia″-2), (Ia″-3), or (DOT); and
a photo-initiator chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof, preferably BAPO.

In a more particular embodiment, the composition of the invention comprises:
a first monomer M1 chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), triethylene glycol dimethacrylate (TEGDMA), polyethylene glycol diacrylate (PEGDA), diurethane dimethacrylate (UDMA), bisphenol A glycidyl methacrylate (Bis-GMA), bisphenol A ethoxylate diacrylate (Bis-EDA) and mixtures thereof, preferably PETIA;
a second monomer M2 which is a compound of formula (Ia), preferably selected from the group consisting of compounds of above formula (Ia″-1), (Ia″-2), (Ia″-3), or (DOT); and
a photo-initiator chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof, preferably BAPO.

In a particular embodiment, the composition of the invention comprises:
a first monomer M1 chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), ethylene glycol diacrylate, diethylene glycol diacrylate, triethylene glycol diacrylate, polyethylene glycol diacrylate (PEGDA), propylene glycol diacrylate, dipropylene glycol diacrylate, tripropylene glycol diacrylate, polypropylene glycol diacrylate, bisphenol A ethoxylate diacrylate (Bis-EDA), ethylene glycol dimethacrylate, diethylene glycol dimethacrylate, triethylene glycol dimethacrylate (TEGDMA), polyethylene glycol dimethacrylate, propylene glycol dimethacrylate, dipropylene glycol dimethacrylate, tripropylene glycol dimethacrylate, polypropylene glycol dimethacrylate, 2,2-bis-4-(methacryloxy ethoxy)phenylpropane, tricylodecane dimethanol dimethacrylate, 1,10-decanediol dimethacrylate, 1,6-hexanediol dimethacrylate, 1,9-nonanediol dimethacrylate, neopentylglycol dimethacrylate, 2-hydroxy 1,3-dimethacryloxy propane, trimethyolpropane trimethacrylate, ethoxylated trimethyol propane trimethacrylate, ditrimethyolpropane tetramethacrylate, tris (2-hydroxy ethyl) isocyanurate trimethacrylate, diurethane dimethacrylate (UDMA), dipentaerythritol pentamethacrylate, ethyoxylated pentaerythritol tetramethacrylate, propoxylated glyceryl trimethacrylate, propoxylated trimethylolpropane trimethacrylate, bisphenol A glycidyl methacrylate (Bis-GMA), and mixtures thereof, preferably PETIA;
a second monomer M2 which is a compound of formula (Ib), preferably selected from the group consisting of compounds of above formula (SCM1), (SCM2), (SCM3), (SCM4), (SCM5), (SCM6), or (SCM7), more preferably (SCM1) or (SCM2); and
a photo-initiator chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof, preferably BAPO.

In a more particular embodiment, the composition of the invention comprises:
a first monomer M1 chosen from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), triethylene glycol dimethacrylate (TEGDMA), polyethylene glycol diacrylate (PEGDA), diurethane dimethacrylate (UDMA), bisphenol A glycidyl methacrylate (Bis-GMA), bisphenol A ethoxylate diacrylate (Bis-EDA) and mixtures thereof, preferably PETIA;
a second monomer M2 which is a compound of formula (Ib), preferably selected from the group consisting of compounds of above formula (SCM1), (SCM2), (SCM3), (SCM4), (SCM5), (SCM6), or (SCM7), more preferably (SCM1) or (SCM2); and
a photo-initiator chosen from phenylbis(2,4,6-trimethylbenzoyl)phosphine oxide (BAPO, Irgacure 819), azobisisobutyronitrile (AIBN), acide 4,4′-azobis(4-cyanopentanoique), 1,1′-azobis (cyclohexane carbonitrile), tert-butyl peroxide, benzoyl peroxide, benzophenone, 2-hydroxy-2-methyl-1-phenyl-propan-1-one (Irgacure 1173), 2-hydroxy-4′-(2-hydroxyethoxy)-2-methylpropiophenone (Irgacure 2959), 2-methyl-4′-(methylthio)-2-morpholinopropiophenone (Irgacure 907), 2,2′-azobis[2-methyl-n-(2-hydroxyethyl)propionamide] (VA-086), 2,2-dimethoxy-2-phenylacetophenone (Irgacure 651 or DMPA), (2,4,6-Trimethylbenzoyl)diphenylphosphine oxide (Darocure TPO or Lucirin TPO), lithium (2,4,6-Trimethylbenzoyl)phenylphosphinate (LAP), ethyl (2,4,6-trimethylbenzoyl)phenylphosphinate (Lucirin TPO-L) and mixtures thereof, preferably BAPO.

In a preferred embodiment, the composition of the invention comprises:
a first monomer M1 which is PETIA;
a second monomer M2, which is a compound of formula (Ia) or (Ib), preferably DOT; and
a photo-initiator which is BAPO.

In another preferred embodiment, the composition of the invention comprises:
a first monomer M1 which is PETIA;
a second monomer M2, which is a compound of formula (Ia), preferably selected from the group consisting of compounds of above formula (Ia″-1), (Ia″-2), (Ia″-3), or (DOT), more preferably DOT; and
a photo-initiator which is BAPO.

In another preferred embodiment, the composition of the invention comprises:
a first monomer M1 which is PETIA;
a second monomer M2, which is a compound of formula (Ib), preferably selected from the group consisting of compounds of above formula (SCM1), (SCM2), (SCM3), (SCM4), (SCM5), (SCM6), or (SCM7), more preferably (SCM1) or (SCM2); and
a photo-initiator which is BAPO.

The light-activated resin composition of the invention can further comprise any suitable solvent, for instance a solvent chosen among alcohols (such as methanol, ethanol, propanol, isopropanol), ethers, ketones (such as a linear or cyclic ketone, for instance acetone or cyclohexanone), alkanes (such as a linear or cyclic alkane, for instance hexane or cyclohexane), and aromatic hydrocarbons (such as toluene). Preferably, the composition of the invention does not comprise a solvent.

The composition of the invention can further comprise any suitable additives, in particular additives that are usually comprised in 3D-printing resin compositions. For instance, the composition of the invention may further one or more additives chosen from light absorbers, light stabilizers, light blockers, inhibitors, organic or inorganic fillers (such as organic or inorganic nanoparticles, for instance such as TiO2, SiO2, metal nanoparticles), surfactants, pigments, or colorants (such as photochroms and photo-isomerisable compounds).

The composition of the invention can be prepared by mixing in any order the components comprised therein. The mixing can typically be carried out at room temperature, preferably for a duration comprised between 1 hour and 10 days, for instance between 1 day and 5 days. As used herein, the expression “room temperature” refers to a temperature comprised between 5° C. and 40° C., preferably between 15° C. and 30° C. Preferably, the mixing is carried out in the absence of light. The composition of the invention is advantageously liquid or semi-liquid.

In an embodiment where the monomer M1 is in a prepolymer form, the preparation of the composition of the invention may comprise a preliminary step of forming a prepolymer of the monomer M1, before adding the others components (i.e. monomer M2, photoinitiator, and the optional additives).

A degradable polymer (or equivalently, a degradable resin) can be produced by irradiating the light-activated resin composition of the invention. Hence, another object of the invention is a photopolymerization process comprising irradiating a light-activated resin composition as defined herein. As mentioned above, the irradiating step is carried out by means of a source of light (or equivalently “light radiation”), such as a laser (e.g. a continuous-wave laser or a pulsed laser), a laser diode, a lamp, a DLP projector, a LCD (liquid-crystal display) projector, or a LED (light-emitting diode). The light (radiation) can be composed of one or more wavelength(s) comprised between 100 nm and 1500 nm. Preferably, said light is an ultra-violet (UV) light, a visible light, or a near-infra-red (IR) light.

In a preferred embodiment, the light source is a UV light source. Examples of UV light source include, but are not limited to, a UV laser, a UV laser diode, a UV lamp (for instance, a mercury vapor lamp or a xenon lamp), a DLP projector, a LCD projector, or a LED.

The light may be a continuous or pulsed light. The duration of pulses of the pulsed light may be of the order of microsecond, nanosecond or femtosecond.

Generally speaking, the conditions of the photopolymerization process of the invention and more particularly, the irradiating step, can be similar to the conditions used in known photopolymerization processes of known acrylate or methacrylate resin compositions. For instance, the photopolymerization process can be carried out under conditions of single-photon or multiphoton (in particular two-photon) photopolymerization processes. Furthermore, the equipment for implementing the photopolymerization process of the invention and more particularly, the irradiating step, can be similar to the equipment used in known photopolymerization processes of known acrylate or methacrylate resin compositions. For instance, the above-discussed light source can be applied to the resin composition of the invention using an installation comprising optics, mirror galvanometers, masks, lenses, and/or diffraction gratings.

The photopolymerization process of the invention produces a polymer (or equivalently, resin) that is degradable. Another object of the present invention is a degradable polymer obtained by the photopolymerization process of the invention.

Another object of the present invention is a degradable polymer based on the light-activated resin composition as defined herein.

As used herein, a “polymer based on the light-activated resin composition” refers to a polymer comprising (preferably consisting of) the reaction product(s) of the components of said composition that are involved in the photopolymerization. Said components involved in the photopolymerization are compounds reacting with each other to form polymer chains and/or polymer networks, during photopolymerization. In the composition of the invention, such components typically comprise said first and second monomers, and said photo-initiator. Said polymer may be in a mixture with components that are not involved in the photopolymerization, such as additives, residual monomers, residual photo-initiators, or any by-products. The polymer of the invention may be based on a composition of the invention comprising an amount of first monomer from 40 to 98.9 wt %, preferably from 60 to 98 wt %, relative to the total weight of the composition, a weight ratio of the second monomer M2 to the first monomer M1 of from 1/100 to 20/100, preferably from 1/100 to 5/100, more preferably from 1/100 to 3/100, for instance from 1.5/100 to 2.5/100, and a weight ratio of photoinitiator to the first monomer M1 of from 1/1000 to 5/100, preferably from 1/1000 to 1/100, more preferably from 2/1000 to 5/1000.

The polymer based on the light-activated composition of the invention or obtained by the photopolymerization process of the invention is degradable, and can be biodegradable. Mild conditions can be applied to said polymer in order to achieve degradation. For instance, said polymer can be degraded by using a basic solution. A basic solution can comprise one or more bases (for instance, a hydroxide such as sodium or potassium hydroxide) in solution or suspension in a solvent (for instance, water, an alcohol such as methanol or ethanol, acetonitrile, acetone, diethyl ether, tetrahydrofuran, toluene, dimethylsulfoxide, or a mixture thereof), for instance, KOH in methanol, water, tetrahydrofuran, or a mixture thereof. Alternatively, said polymer can be composted. The degradation can be carried out at room temperature, or can be accelerated by heating, advantageously at a temperature comprised between 30° C. and 150° C. Depending on the conditions and the size of the sample to be degraded, the degradation of said polymer can occur over several seconds, minutes, hours, or days. For instance, the degradation of a micrometric sample can occur over several seconds, and the degradation of an object of few cm³ can occur over several minutes or hours.

Another object of the present invention is a process for three-dimensional (3D) printing a degradable 3D-printed article. Such 3D-printing process comprises irradiating a light-activated resin composition as defined herein, under conditions allowing the formation of a 3D-printed article.

As used herein, the term “3D-printing” refers to the manufacturing of any 3D article of any size, by curing a liquid or semi-liquid resin composition. The 3D-printing of articles having a thin (such as microsize (i.e. a size in the micron range, typically from 1 μm to 100 μm) or millisize (i.e. a size in the millimeter range, typically from 1 mm to 100 mm)) and constant thickness can also be named herein “2.5D-printing”. The 3D-printing of articles having a microsize (i.e. a size in the micron range, typically from 1 μm to 100 μm) can also be named herein “3D-microfabrication”.

The irradiating step of the 3D-printing process of the invention is carried out by means of a source of light (or equivalently “light radiation”), such as a laser (e.g. a continuous-wave laser or a pulsed laser), a laser diode, a lamp, a DLP projector, a LCD projector, or a LED. The light (radiation) can be composed of one or more wavelength(s) comprised between 100 nm and 1500 nm. Preferably, said light is an ultra-violet (UV) light, a visible light, or a near-infra-red (IR) light.

In a preferred embodiment, the light source is a UV light source. Examples of UV light source include, but are not limited to, a UV laser, a UV laser diode, a UV lamp (for instance, a mercury vapor lamp or a xenon lamp), a DLP projector, a LCD projector, or a LED.

The source of light may be a continuous or pulsed light. The duration of pulses of the pulsed light may be of the order of microsecond, nanosecond or femtosecond.

The conditions of the 3D-printing process can be similar to the conditions used in known 3D-printing processes using known acrylate or methacrylate resin compositions. Furthermore, the 3D-printer and more generally, the equipment for implementing the 3D-printing process of the invention and more particularly, the irradiating step, can be similar to the equipment used in known 3D-printing processes using known acrylate or methacrylate resin compositions. For instance, the above-discussed light source can be applied to the resin composition of the invention using an installation comprising optics, mirror galvanometers, masks, lenses, and/or diffraction gratings. Furthermore, the 3D-printing can be implemented by means of computer aid, which in particular defines the 3D structure of the article to be printed.

In a particular embodiment, the 3D-printing process of the invention is carried out in a vat. In a more particular embodiment, the 3D-printing process is implemented by means of a 3D-printer comprising a vat, a light source as defined above, an elevator and a build platform.

In some embodiments, the 3D-printing process is carried out layer-by-layer. In such embodiment, the 3D-printing process preferably comprises:
(i) providing a layer of a light-activated resin composition as defined herein; and
(ii) irradiating the layer of step (i) so as to obtain a cured light-activated resin layer;
wherein steps (i) and (ii) are repeated cyclically so as to obtain a stacking of cured layers forming the article to be 3D-printed.

More particularly, the 3D-printing process may be carried out by stereolithography (or “SLA”), for instance by biphoton or multiphoton stereolithography. In a 3D-printing process by stereolithography, the irradiating step is typically carried out using a laser, and more particularly, a UV laser.

Alternatively, the 3D-printing may be carried out by digital light processing (or “DLP”). In such embodiment, the irradiating step is typically carried out using a DLP projector.

Alternatively, the 3D-printing may be carried out by daylight polymer printing (or “DPP”). In such embodiment, the irradiating step is typically carried out using a LCD projector.

In some other embodiments, the 3D-printing process is carried out continuously (i.e. not layer-by-layer). More particularly, the 3D-printing process may be carried out by continuous liquid interface production (or “CLIP”). In such embodiment, the irradiating step is typically carried out using a UV-light.

Another object of the present invention is a degradable 3D-printed article based on (or comprising, or consisting of) a degradable polymer of the invention. Another object of the present invention is a degradable 3D-printed article obtained by the 3D-printing process of the invention.

Said 3D-printed article is degradable, and can be biodegradable. Mild conditions can be applied to said article in order to achieve degradation. Examples of degradation conditions are those described above for the degradable polymer of the invention.

The present invention also relates to the use of a monomer comprising a thionolactone or sulfide cyclic methacrylate as defined herein (such as a compound of formula (Ia) or (Ib)), for preparing a degradable 3D-printed article as defined herein.

The present invention also relates to the use of a monomer comprising a thionolactone or sulfide cyclic methacrylate as defined herein (such as a compound of formula (Ia) or (Ib)), for preparing a light-activated resin composition suitable for 3D-printing.

The present invention also relates to the use of a monomer comprising a thionolactone or sulfide cyclic methacrylate as defined herein (such as a compound of formula (Ia) or (Ib)), for preparing a light-activated resin composition suitable for 3D-printing a degradable article.

Another object of the present invention is a compound of following formula (Ia″-1) or (Ia″-2) or (Ia″-3):

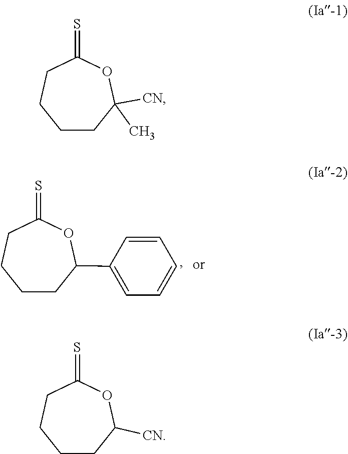

The invention will also be described in further detail in the following examples, which are not intended to limit the scope of this invention, as defined by the attached claims.

### EXAMPLES

### Materials & Methods

All reagents and solvents were used as received. Pentaerythritol triacrylate, isopropylamine, phenylbis(2,4,6-trimethylbenzoyl)phosphine oxide) (BAPO), ammonia (4% in MeOH, 2.0 mol/L) and 1,5,7-triazabicyclo[4.4.0]dec-5-ene (TBD), and SPLINT resin were commercially available. Dibenzo[c,e]-oxepane-5-thione (DOT) was synthetized according to the literature procedure (Bingham, et al., Chem. Commun. 2019, 55, 55-58). 2-Methylene-1,3-Dioxepane (MDO) was synthetized according to the literature procedure (Bailey, et al., J. Polym. Sci. Part A Polym. Chem. 1982, 20, 3021-3030).

FDM of polypropylene molds was performed on a Ultimaker 2+ from Ultimaker. Cura software was used to generate the G-code printing files. Polypropylene filament was purchased from Ultimaker. The nozzle temperature was set at 230° C. and bed temperature at 100° C. All the layers were printed a 100% speed without fan cooling. The bed was heating at 100° C. during 30 min before the print. Preliminary photopolymerization in polypropylene molds (PP molds) was done with a Hamamatsu Photonics K.K. LC-L5 lamp at 365 nm during 30 s for all samples. ¹H NMR spectra were measured on a Bruker AC 400 (400 MHz) or a Bruker AC 300 (300 MHz) spectrometer at 298 K (20° C.). Data were reported as follows: chemical shifts in ppm referenced to the internal solvent signal (peak at 7.26 ppm in the case of CDCl₃), multiplicity (s=singlet, d=doublet, t=triplet, q=quadruplet, quint=quintuplet, dd=double-doublet, m=multiplet, bs=broad, app=apparent) and coupling constants (Hz). ¹³C {¹H} NMR spectra were measured on a Bruker AC 400 (100 MHz) or a Bruker AC 300 (75 MHz) spectrometer with complete proton decoupling. Chemical shifts were reported in ppm from the internal solvent signal (peak at 77.16 ppm in the case of CDCl₃, peak at 53.84 in the case of CD2Cl₂). The experiments were performed with a commercial Bruker double-bearing probe with zirconium dioxide rotors of 4-mm outer diameter. For Cross Polarization (CP) MAS experiments, typical parameters were 5 ms contact time, 5 s recycle delays, 8192 scans and spin rate of 10 kHz. A ramped ¹H pulse was used to circumvent Hartman-Hahn mismatches (O.B. Peersen, X Wu, I. Kustanovich, S. O. Smith, J. Magn. Reson. 1993, 104, 334-339) To improve the resolution, a dipolar decoupling TPPM-15 pulse sequence was applied during the acquisition time. The experiments were performed at ambient temperature. Chemical shifts were referenced to tetramethyl silane, whose resonance was set to 0 ppm.

The products were purified by flash column chromatography on silica gel 60 (Macherey-Nagel® Si 60, 0.040-0.063 mm).

A UV-laser diode emitting at 375 nm is injected into a single-mode optical fiber (SMF-28e from Corning, core Ø: 8 μm) using an objective with a numerical aperture of 0.4. 3D printing was performed with a DLP projector (IkarusFull-HD DLP6500 light engine module from Invision) which allow projecting a 2980×1080 pixels image (λᵢᵣᵣ=365 nm, irradiance=10 mW·cm⁻²).

PP molds were printed on a Ultimaker 2+ from Ultimaker. Cura software was used to generate the G-code printing files. Polypropylene filament was purchased from Ultimaker. The nozzle temperature was set at 230° C. and bed temperature at 100° C. All the layers were printed a 100% speed without fan cooling. The bed was heating at 100° C. during 30 min before the print

### Synthesis of Compound (Ia″-2=POT):

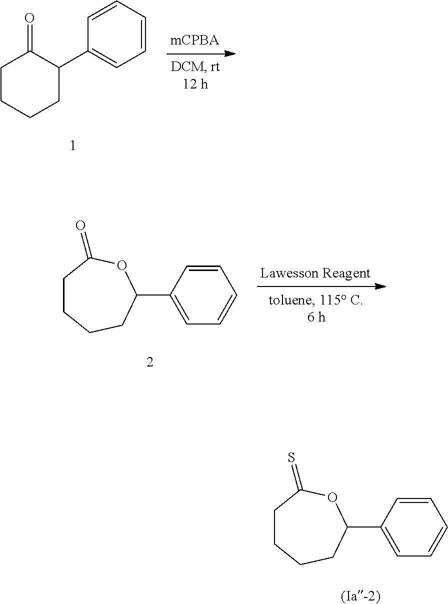 [SMILES: O=C1CCCCC1c1ccccc1 ; O=C1CCCCC(c2ccccc2)O1 ; S=C1CCCCC(c2ccccc2)O1]

### Synthesis of 2

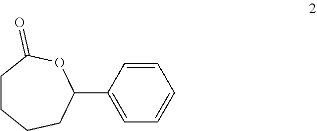 [SMILES: O=C1CCCCC(c2ccccc2)O1]

2 was synthesized following the procedure described in Chem. Soc. 2013, 19, 2606 To a solution of 1 (0.2 M in DCM, 3.0 g, 17.2 mmol, 1.0 eq.) was added mCPBA (7.1 g, 41.3 mmol, 2.4 eq.) at 0° C. After stirring at rt during 12 h, the reaction mixture was quenched with 10% K₂CO₃ solution and a saturated aqueous solution of Na₂S₂O₃. The aqueous layer was separated and extracted with dichloromethane. The combined organic layers were dried over MgSO4, filtered, and concentrated under vacuum. The resulting product was purified by flash chromatography on silica gel using 10-30% EtOAc in pentane as eluent to afford 2 as a white solid (3.1 g, 93%).

¹H NMR (400 MHz, Chloroform-d) δ 7.36-7.20 (m, 5H), 5.22 (d, J=9.3 Hz, 1H), 2.69 (m, 2H), 2.11-1.88 (m, 4H), 1.76-1.57 (m, 2H).

### Synthesis of (Ia″-2)

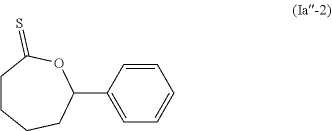 [SMILES: S=C1CCCCC(c2ccccc2)O1]

A mixture of 2 (0.5 g, 9.64 mmol, 1.0 eq.) and Lawesson reagent (0.88 g, 2.18 mmol, 0.6 eq.) were solubilized in anhydrous toluene, under inert atmosphere. The suspension was refluxed during 6 h. After cooling to room temperature, the solution was half concentrated and filtered on a plug of silica gel. The filtrate was concentrated under vacuum. The crude product was purified by flash chromatography on silica gel using 20% EtOAc in pentane as eluent, to afford compound (Ia″-2) as a dark oil (2.3 g, 53%).

¹H NMR (400 MHz, Chloroform-d) δ 7.53-7.31 (m, 5H), 5.66-5.49 (d, J=9.3 Hz, 1H), 3.61 (m 1H), 3.08 (m, 1H), 2.17-2.05 (m, 4H), 1.94-1.67 (m, 2H).

### Synthesis of 6-methylene-1,4-oxathiepan-7-one synthesis (=M4=compound SCM1)

Adapted from J. Am. Chem. Soc. 2009, 131, 9805

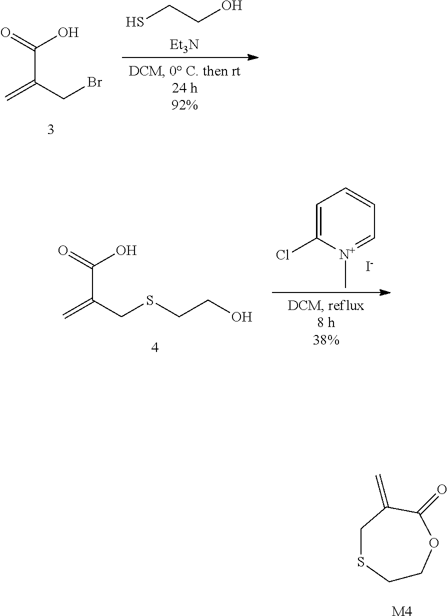

### Synthesis of 4

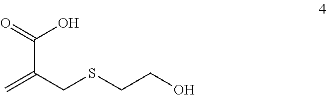

4 was synthesized according to the following procedure: triethylamine (5.18 mL, 37.3 mmol, 2.0 eq.) was added dropwise to a cooled (0° C.) solution of R-bromomethylacrylic acid (3) (3.07 g, 18.6 mmol, 1.0 eq.) in dichloromethane (100 mL). 6-Mercapto-1-hexanol (2.50 g, 18.6 mmol, 1.0 eq.) was then added over a period of 15 min, and the reaction mixture was stirred during 20 h. A solution of ammonium sulfate (9.0 g, 78.8 mmol, 4.2 eq.) and sulfuric acid (5 mL, 2 M, 10 mmol) in water (100 mL) was cooled to 0° C., and the reaction mixture was poured into it. This mixture was extracted with diethyl ether (3×60 mL). The combined organic layers were dried over magnesium sulfate and concentrated under vacuum yielding 4 as white solid (3.72 g, 92%).

¹H NMR (400 MHz, Chloroform-d) δ 6.80-6.67 (m, 1H), 6.23 (s, 1H), 4.71 (d, J=6.0 Hz, 2H), 4.35 (s, 2H), 3.63 (t, J=6.0 Hz, 2H).

Synthesis of M4 (=compound SCM1)

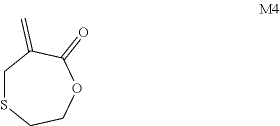

M4 was synthesized according to the following procedure: 4 (1.5 g, 6.87 mmol, 1.0 eq.) was dissolved in a mixture of dichloromethane (60 mL) and triethylamine (7.6 mL, 55.0 mmol, 8.0 eq.) and added via syringe pump over a period of 8 h to a refluxing solution of 2-chloro-1-methylpyridinium chloride (7.0 g, 27.5 mmol, 4.0 eq.) in dichloromethane (650 mL). The reaction mixture was cooled down to room temperature and filtered. The solvent was evaporated under vacuum, and the crude was dissolved in water (100 mL) and extracted with diethyl ether (3×30 mL). The combined organic layers were dried with magnesium sulfate, and evaporation of solvent gave an orange liquid. The crude product was purified via flash column chromatography with dichloromethane as eluent and yielding M4 as a pale-yellow solid (410 mg, 30%).

¹H NMR (400 MHz, Chloroform-d) δ 5.84 (s, 1H), 5.59 (t, J=1.3 Hz, 1H), 4.55-4.44 (m, 2H), 3.36 (d, J=1.2 Hz, 2H), 2.99-2.90 (m, 2H).

### Example 1. Preparation of Resin Compositions of the Invention

General procedure for “DOT-PETIA resin”: 2 wt % of DOT and 0.2 wt % of BAPO photo-initiator were mixed with triacrylate PETIA. The mixture was stirred during 3 days at room temperature away from the light.

For PETIA resin (comparative resin): 0.2 wt % of BAPO photo-initiator was mixed with triacrylate PETIA. The mixture was stirred during 3 days at room temperature away from the light.

### Example 2. FTIR Characterization and Mechanical Properties of the Polymer of the Invention

The photopolymerization was monitored in situ by real-time Fourier transformed infrared spectroscopy with a Thermo-Nicolet 6700 IR-spectrometer. KBr pellets were used as substrates and a polypropylene film was used to avoid interaction with atmosphere. Irradiation was performed in situ using a 100 W Mercury-Xenon Lamp (LC 9588/02A from Hamamatsu) equipped with a band pass filter centred at 365 nm (A9616-07 from Hamamatsu). The conversion ratio was calculated from the decrease of the 1635 cm⁻¹ band.

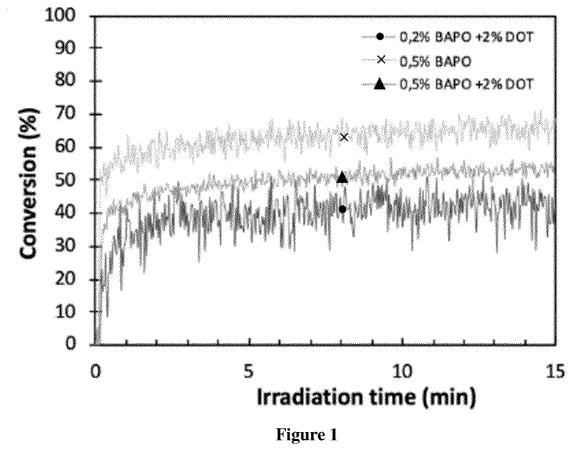

The kinetics of the photopolymerization obtained by FTIR are plotted in FIG. 1. They are based on monitoring the C═C conversion of the acrylate functions in the monomer. With a BAPO concentration of 0.5 wt %, the polymerization is efficient, leading to a final conversion of more than 60% and a conversion plateau quickly reached. This type of kinetics is classical for such a triacrylate monomer. The trifunctional character ensures a very fast initial polymerization speed, then the rapid increase in viscosity leads to an important gelification of the medium which stops the polymerization and prevents a higher conversion. The addition of DOT (2 wt %) slightly decreases the efficiency of the photopolymerization, both for the initial speed and the final conversion (50%), but keep them still totally compatible to an 3D printing process. It can be observed that it is possible to reduce the concentration of BAPO to 0.2 wt %, while maintaining effective polymerization, with in particular sufficient cross-linking of the polymer to confer interesting mechanical properties to the material, as observed qualitatively after irradiation.

Mechanical tests were performed with the INSTRON 4505 Dynamometer modernized ZWICK/ROELL (TestXpert II software). As shown in Table 1, the addition of DOT only sligthly modifies the mechanical properties of the polymer by leading to a slightly softer and less brittle polymer. Young modulus, tensile strength and elongation values remain in the same order of magnitude.

TABLE 1

| | 0.2% BAPO | 0.2% BAPO + 2% DOT |
|---|---|---|
| E = Young modulus (MPa) | 1160 ± 76 | 1120 ± 60 |
| σ = Tensile strength (MPa) | 3.5 ± 0.85 | 10.4 ± 1.37 |
| A = elongation (%) | 0.40 ± 0.18 | 1.1 ± 0.19 |

### Example 3. 3D-Manufacturing Using the Composition Resin of the Invention

### 1) Microstructuring on Optical Fiber

A laser microstructuring configuration was used to demonstrate the ability of the polymer of the invention to be used for laser-induced 3D microfabrication.

A UV-laser diode emitting at 375 nm is injected into a single-mode optical fiber (SMF-28e from Corning, core Ø: 8 μm) using an objective with a numerical aperture of 0.4. A droplet of the resin was vertically suspended on the other side of the fiber. The capillarity effect ensures the formation of quasi-hemispherical droplet with a radius of ˜50 μm. The micro-tip was then photogenerated upon irradiation with an output powers between 1 μW and 10 μW at the surface of the fiber. After rinsing by immersion for a few seconds in ethanol, the microtip is obtained on the optical fiber.

### 2) 3D-Printing

Two different setups were used for 3D printing:

For DLP printing, we used a DLP projector (IkarusFull-HD DLP6500light engine module from Invision) which allows projecting a 2980×1080 pixels image ((λᵢᵣᵣ=365 nm, irradiance=10 mW cm⁻²). The resin was casted on a reservoir and covered by a microscope slide. After exposure, the unreacted resin was removed by rinsing with ethanol. 2.5D samples can be prepared using this setup. 3D Printing was performed on a Miicraft 125 series from Miicraft with a layer thickness of 50 m (385 nm UV-LED, 1 s exposition time per layer, 7 s exposition time for the first layer, 4 buffer layer, 80% powerful). Utility software was used to generate mii-code printing files.

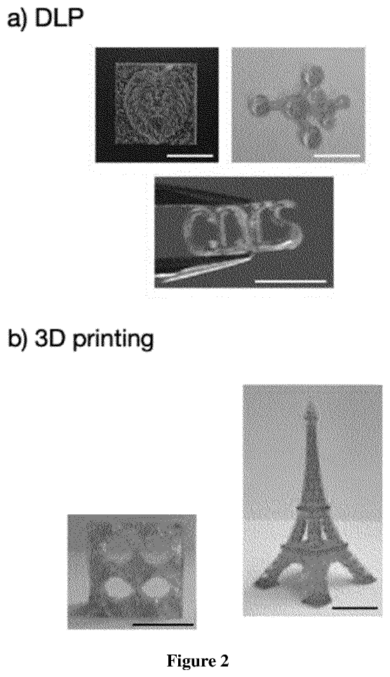

Different objects were manufactured, with different geometries, as shown in FIG. 2 using both setups, which are interesting to build 2.5 and 3D objects with arbitrary shapes. A residual yellow coloration can be visible but the parts keep their transparency. For relatively thin objects, the coloration can be attenuated after bleaching.

### Example 4. Degradation Tests

All degradation tests were performed at room temperature without stirring. The articles were immersed in THE and in the same volume of a solution of 5 wt % of KOH in MeOH.
Tips were degraded by immersion of the end of the optical fiber in the degradation solution.

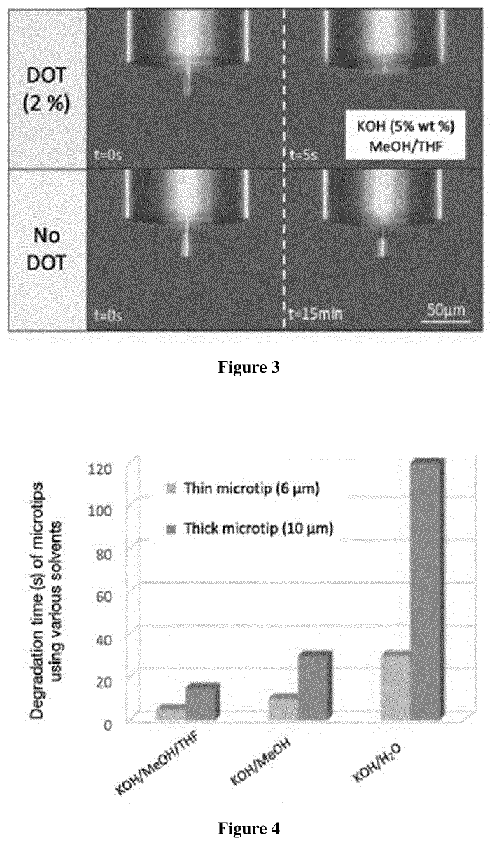

FIG. 3 shows that without DOT, the microtip remains attached to the end of the optical fiber after 15 min, while the rip is degraded after only 5 seconds with DOT in the resin. As shown in FIG. 4, various degradation solutions were tested: 5 wt % KOH in MeOH/THF 1:1 (v/v), 5 wt % KOH in MeOH, and 5 wt % KOH in water. Best results were obtained with 5 wt % KOH in MeOH/THF 1:1 (v/v).
DLP objects were immersed for several durations in the degradation solution: 5 wt % KOH in MeOH/THF 1:1 (v/v).

FIG. 5 demonstrates that the material is degraded in the volume. The Dali mask is a macroscopic object fabricated by DLP-UV. This object was immersed in the degradation solution. After 17 h, the object is taken out of the solution and placed on a substrate to be photographed. One can easily notice the already started degradation of the object. After 24 h, this degradation is even more marked and finely, after 90 h, the object is no longer visible in the solution. This result therefore undoubtedly confirms the role of DOT in the degradation mechanism.
Tablets: Cm-scale small tablets were prepared using a polypropylene mold previously printed by FDM. The weight and visual aspect of these tablets were monitored during the decomposition process. the use of 5 wt % of KOH in MeOH/THF led to the complete dissolution of the pellet in 1 week whereas the reference pellet was not degraded in 3 months.

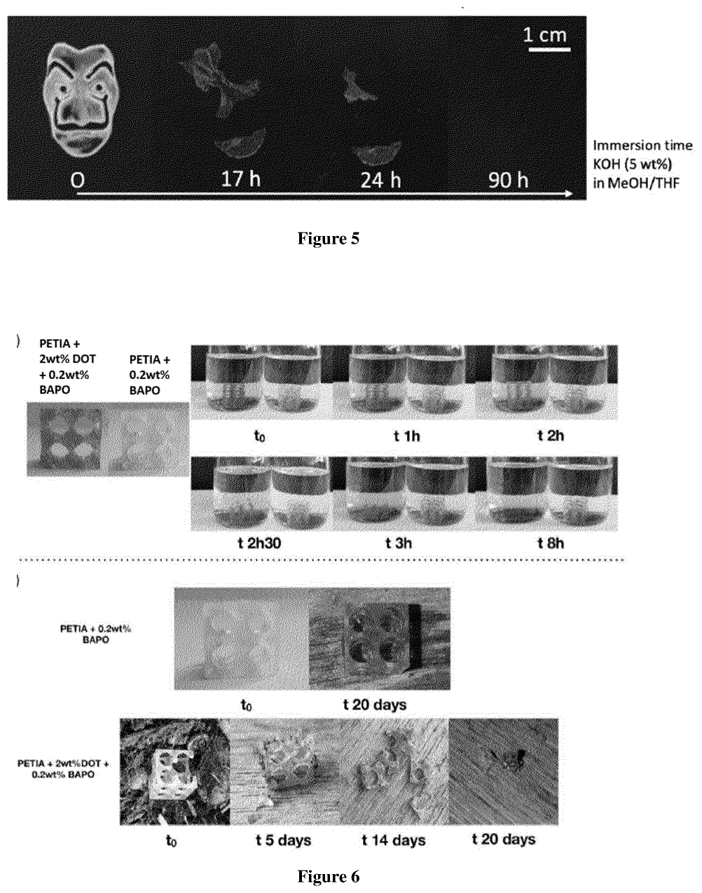

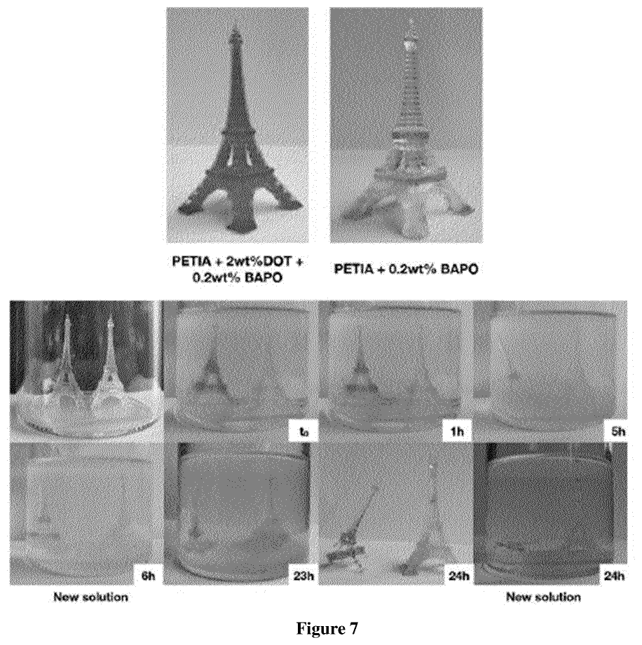

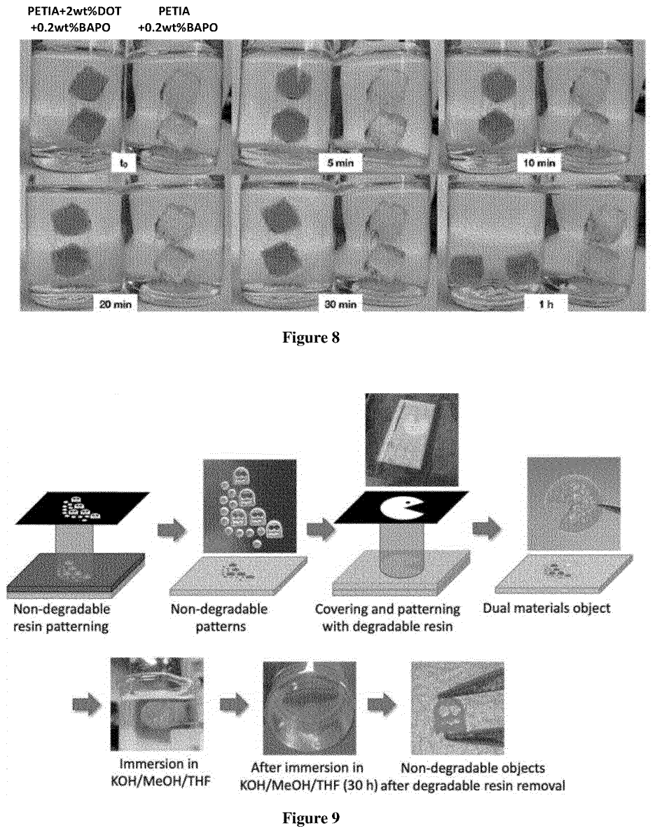

To speed-up the degradation, the concentration of KOH and/or the temperature were increased. Using the following degradation conditions: 120° C., 10 wt % KOH in MeOH/THF, 24 h, the complete dissolution of this dense cm-scale object could be obtained in 17 h.
3D printing: the same solution was used for different times (FIGS. 6—top, 7 and 8). More specifically, a solution of KOH 5 wt % in MeOH was used for the 3D objects degradation with the same volume of THE at room temperature without stirring:
   8 h for hollow cube
   24 h for Eiffel tower
   1 h for stacked dices

### Home-Made Compost Degradation:

Composter from EDC with a volume of 400 L was used for this experiment. Degradation was carried out in the South of France in Spring 2021. Every two days, household waste (peelings, fruits, vegetables, fresh and dried herbs and water) was added and the compost is regularly stirred. The hollow cube was observed during the addition of organic matter and the degradation was visually monitored (FIG. 6—bottom). After 20 days in the compost, the DOT/PETIA cube was quite totally degraded whereas the cube made from PETIA without DOT was not altered.

### Example 5. Combining 3D-Printing and Degradation

The degradation ability of the PETIA/DOT polymer combined with the stability of PETIA makes it possible to consider manufacturing objects with degradable and non-degradable parts using the same DLP-UV printer. This possibility is demonstrated in FIG. 9. In this example, the strategy is as follows: in a first step, objects (ghosts and balls) are made with the non-degradable PETIA/BAPO resin. The object is then placed in the degradable resin with 2 wt % DOT and a second pattern is printed (Pacman figure). At the end, the object is a Pacman head in which objects are included. This matrix is soluble in the solution 5 wt % KOH in MeOH/THF and its dissolution releases the included objects, which are not degraded in the time necessary for the disappearance of the degradable matrix.

### Example 6. Polymerization Studies

### Polymerization in PP Molds

### Experiment

The resin composition was prepared as in example 1:
Formulation DOT=PETIA (97.8 wt %), BAPO (0.2 wt %), DOT (2 wt %)—the resin was stirred until solubilization of all the compounds.

Resins were then casted in polypropylene molds (PP molds) and photopolymerization was done with a Hamamatsu Photonics K.K. LC-L5 lamp at 365 nm during a given time and power (see above section “Material and methods”).

### Degradation

Pellets obtained after photopolymerization were refluxed in KOH (10 wt %) in MeOH/THF (1/1) until complete solubilization (4 h).

The solution was filtered, and the filtrate was neutralized with HCl (10%) until pH˜7. Extraction with dichloromethane and concentration under vacuum.

### Recycling

The degradation residue obtained after concentration was mixed with BAPO (1 wt %) and PETIA (30 wt %) until complete solubilization. The solution mixture was casted in PP molds and photopolymerized during 30 s at 1200 mV. A solid was obtained after photopolymerization.

### DLP Polymerization

### Experiment

The resin compositions were prepared as in example 1:
Formulation DOT=PETIA (97.8 wt %), BAPO (0.2 wt %), DOT (2 wt %)—the resin was stirred until solubilization of all the compounds.
Formulation (1a″-2)=PETIA (91.8 wt %), BAPO (0.2 wt %), compound (1a″-2) (8 wt %)—the resin was stirred until solubilization of all the compounds.
formulation SCM1 (M4) (4 wt %): PETIA (95.8 wt %), BAPO (0.2 wt %), SCM1 (4 wt %)—the resin was stirred until solubilization of all the compounds.
formulation SCM1 (M4) (8 wt %): PETIA (91.8 wt %), BAPO (0.2 wt %), SCM1 (8 wt %)—the resin was stirred until solubilization of all the compounds.

The resins were casted between two optical fibers (Ø=250 μm) and covered by a microscope slide. After exposure, the DLP-printed object was rinsed with ethanol to remove the unreacted resin (see experiment on example 3).

Degradation was performed by diving the object in a KOH (5 wt %) MeOH/THF 1/1 solution until complete dissolution, at room temperature, without stirring (see experiment on example 4).

### Results

| | DOT | (1a″-2, POT) | SCM1 | SCM1 |
|---|---|---|---|---|
| Formulation | (2 wt %) | (8 wt %) | (4 wt %) | (8 wt %) |
| Polymerization | √ | √ | √ | √ |
| Exposure time | 20 s | 20 s | 2 min | 2 min |
| Degradation | Room | Room | 80° C.: √ | 80° C.: √ |
| | temperature: √ | temperature: √ | | |
| Observation | — | — | Bleaching | Bleaching |

1-23. (canceled)

24. A light-activated resin composition comprising:
a first monomer (M1) comprising at least two functions independently selected from an acrylate function and a methacrylate function;
a second monomer (M2), being a cyclic monomer able to undergo radical ring-opening and comprising a moiety selected from the group consisting of thiocarbonyl-oxy, carbonyl-oxy, carbonyl-thio, disulfide, silyl ether, and acetal, wherein the polymerization rate of M2 is similar to or higher than that of M1; and
a photo-initiator.

25. The light-activated resin composition according to claim 24, wherein said second monomer M2 comprises a thiocarbonyl-oxy moiety.

26. The light-activated resin composition according to claim 24, wherein said second monomer M2 comprises a moiety selected from the group consisting of carbonyl-oxy and carbonyl-thio.

27. The light-activated resin composition according to claim 24, wherein said second monomer M2 comprises a thionolactone or sulfide cyclic methacrylate.

28. The light-activated resin composition according to claim 24, wherein said second monomer M2 is represented by the following formula (Ia): 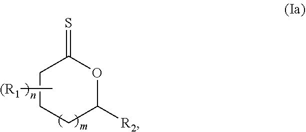
wherein:
m is 0, 1, 2 or 3,
n is from 0 to (2m+5), and
each R₁ is independently selected from the group consisting of a hydrogen, a halogen, a C₁-C₆ alkyl, a C₂-C₆ alkenyl, a C₂-C₆ alkynyl, a C₁-C₆ heteroalkyl, a C₃-C₁₂ cycloalkyl, a heterocycloalkyl, an aryl, a heteroaryl, a cyano, a nitro, —C(O)OH, —C(O)H, —OH, —SH, a C₁-C₆ perfluoroalkyl, an ester, a ketone, a sulfonyl, and an amido,
R₂ is selected from the group consisting of a hydrogen, a halogen, a C₁-C₆ alkyl, a C₂-C₆ alkenyl, a C₂-C₆ alkynyl, a C₁-C₆ heteroalkyl, a C₃-C₁₂ cycloalkyl, a heterocycloalkyl, an aryl, a heteroaryl, a cyano, a nitro, —C(O)OH, —C(O)H, —OH, —SH, a C₁-C₆ perfluoroalkyl, an ester, a ketone, a sulfonyl, and an amido,
or two adjacent R₁ or adjacent R₁ and R₂, can form together with the carbon atoms to which they are attached a C₃-C₁₂ carbocycle.

29. The light-activated resin composition according to claim 24, wherein said second monomer is selected in the group consisting of:

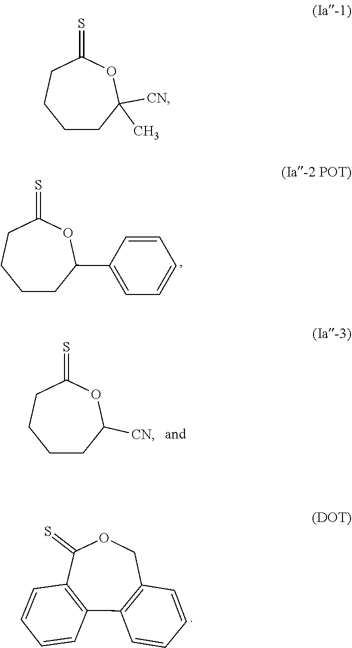 [SMILES: CC1(C#N)CCCCC(=S)O1 ; S=C1CCCCC(c2ccccc2)O1 ; N#CC1CCCCC(=S)O1 ; S=C1OCc2ccccc2-c2ccccc21]

30. The light-activated resin composition according to claim 24, wherein said second monomer is represented by the following formula (DOT):

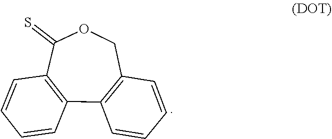 [SMILES: S=C1OCc2ccccc2-c2ccccc21]

31. The light-activated resin composition according to claim 24, wherein said second monomer is represented by the following formula (Ib): 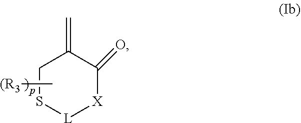
wherein:
X is O or S,
L represents an alkylene chain having k carbon atoms and being optionally interrupted by one or more groups independently chosen from —C(O)O— and —S—S—,
k is from 1 to 11,
p is from 0 to (2k+2), and
each R₃ is independently selected from the group consisting of a hydrogen, a halogen, a C₁-C₆ alkyl, a C₂-C₆ alkenyl, a C₂-C₆ alkynyl, a C₁-C₆ heteroalkyl, a C₃-C₁₂ cycloalkyl, a heterocycloalkyl, an aryl, a heteroaryl, a cyano, a nitro, —C(O)OH, —C(O)H, —OH, —SH, a C₁-C₆ perfluoroalkyl, an ester, a ketone, a sulfonyl, and an amido,
or two adjacent R₃ can form together with the carbon atoms to which they are attached a C₃-C₁₂ carbocycle.

32. The light-activated resin composition according to claim 31, wherein said second monomer is selected in the group consisting of:

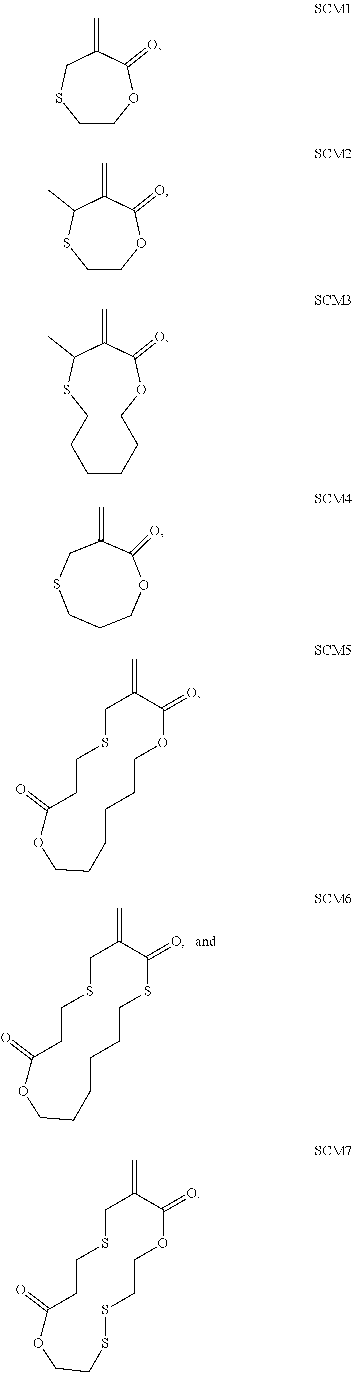

33. The light-activated resin composition according to claim 24, wherein the weight ratio of the second monomer M2 to the first monomer M1 is from 1/100 to 20/100.

34. The light-activated resin composition according to claim 24, wherein said first monomer is selected from pentaerythritol triacrylate (PETIA), pentaerythritol tetra-acrylate (PETEA), propoxylated glycerin triacrylate (EB53), glycerol triacrylate, trimethylolethane triacrylate, trimethylolpropane triacrylate (TMPTA or TTA), di(trimethylolpropane)tetra-acrylate (DTMPTA), triethylene glycol dimethacrylate (TEGDMA), polyethylene glycol diacrylate (PEGDA), diurethane dimethacrylate (UDMA), bisphenol A glycidyl methacrylate (Bis-GMA), bisphenol A ethoxylate diacrylate (Bis-EDA) and mixtures thereof.

35. The light-activated resin composition according to claim 24, wherein said first monomer is pentaerythritol triacrylate (PETIA).

36. The light-activated resin composition according to claim 24, wherein said photo-initiator is selected from phenylbis(2,4,6-trimethylbenzoyl)phosphine oxide, azobisisobutyronitrile, acide 4,4′-azobis(4-cyanopentanoique), 1,1′-azobis(cyclohexane carbonitrile), tert-butyl peroxide, benzoyl peroxide, benzophenone, 2-hydroxy-2-methyl-1-phenyl-propan-1-one, 2-hydroxy-4′-(2-hydroxyethoxy)-2-methylpropiophenone, 2-methyl-4′-(methylthio)-2-morpholinopropiophenone, 2,2′-azobis[2-methyl-n-(2-hydroxyethyl)propionamide], 2,2-dimethoxy-2-phenylacetophenone, (2,4,6-Trimethylbenzoyl)diphenylphosphine oxide, lithium (2,4,6-Trimethylbenzoyl)phenylphosphinate, ethyl (2,4,6-trimethylbenzoyl)phenylphosphinate, and mixtures thereof.

37. The light-activated resin composition according to claim 24, wherein the weight ratio of photo-initiator to the first monomer M1 is from 1/1000 to 5/100.

38. A degradable polymer based on the light-activated resin composition according to claim 24.

39. A photopolymerization process comprising irradiating a light-activated resin composition according to claim 24.

40. The photopolymerization process according to claim 39, wherein irradiating is carried out by means of a UV light source, a UV laser, a UV lamp, a DLP projector, a LCD projector, or a LED.

41. A process for 3D-printing a degradable article comprising irradiating a light-activated resin composition according to claim 24, under conditions allowing the formation of a 3D-article.

42. The 3D-printing process according to claim 41, wherein said process is carried out in a vat.

43. A degradable 3D-printed article based on a degradable polymer according to claim 38.
